(19) United States
(12) Patent Application Publication
(10) Pub. No.: US 2016/0139671 A1
(43) Pub. Date: May 19, 2016

(54) METHOD FOR PROVIDING HAPTIC EFFECT IN ELECTRONIC DEVICE, MACHINE-READABLE STORAGE MEDIUM, AND ELECTRONIC DEVICE

(71) Applicant: Samsung Electronics Co., Ltd., Gyeonggi-do (KR)

(72) Inventors: Jin-Ha JUN, Seoul (KR); Ju-Youn LEE, Gyeonggi-do (KR); Jin-Hyoung PARK, Gangwon-do (KR); ln-Hak NA, Gyeonggi-do (KR); Hyun-Jung KIM, Gyeonggi-do (KR); Chang-Han KIM, Gyeonggi-do (KR)

(21) Appl. No.: 15/006,795

(22) Filed: Jan. 26, 2016

Related U.S. Application Data
(63) Continuation-in-part of application No. 14/154,762, filed on Jan. 14, 2014.

(30) Foreign Application Priority Data
Jan. 15, 2013 (KR) 10-2013-0004514

(51) Int. Cl. G06F 3/01; G06F 3/0482; G06F 3/0481; G06F 3/0484; G06F 3/0488

(52) U.S. Cl. CPC G06F 3/016; G06F 3/04847; G06F 3/04883; G06F 3/04817; G06F 3/0482; G06F 3/04842; G06F 2203/014

(57) ABSTRACT

Methods and apparatuses for providing a haptic effect in an electronic device are described. When a user contacts a haptic providing region on a display screen, a haptic effect corresponding to the haptic providing region is generated in response to the detected user input/contact. The haptic effect may include the transformation of at least a portion of the haptic providing region of the display screen.

### PRIORITY

This application is a Continuation-In-Part (CIP) application of U.S. patent application Ser. No. 14/154,762, which was filed in the U.S. Patent and Trademark Office on Jan. 14, 2014, which claims priority under 35 U.S.C. §119(a) to Korean Patent Application Serial No. 10-2013-0004514, which was filed in the Korean Intellectual Property Office on Jan. 15, 2013, the entire disclosures of each of which are incorporated herein by reference.

### BACKGROUND

1. Field of the Disclosure

The present disclosure generally relates to an electronic device (e.g., a portable terminal), and more particularly, to a method for providing a haptic effect in an electronic device.

2. Description of the Related Art

Presently, a plurality of applications may be stored in portable terminals such as, for example, smart phones and tablet Personal Computers (PCs). Objects (i.e., shortcut icons) for executing the respective applications may also be displayed on touch screens of the portable terminals. Hence, the user may execute a desired application in the portable terminal by touching one of the shortcut icons displayed on the touch screen. In addition, visual objects are displayed on the touch screen of the portable terminal in various forms, such as, for example, widgets, pictures, and documents, as well as the shortcut icons.

As such, the portable terminal provides a touch input scheme in which the displayed objects may be touched using an input unit such as, for example, a user's finger, an electronic pen, a stylus pen, etc., and/or a non-contact input scheme such as hovering.

Presently, in some touch screens, when a user inputs a touch, a vibration element generates a vibration pattern that allows the user to feel as if the user had pressed a button.

However, a user may also want to manipulate an application while not viewing the touch screen of the portable terminal, e.g., when self-capturing a photo with one's phone. Furthermore, a need exists for an interface which is convenient and more universally accessible, such as for, e.g., blind or visually impaired people.

### SUMMARY

Accordingly, an aspect of the present disclosure is to provide a method for a user to manipulate an important function of an application, even while not viewing a touch screen of a portable terminal.

According to an aspect of the present disclosure, a method is provided for an electronic device to provide a haptic effect, the method including displaying an application screen including a haptic providing region set by a user on a display, detecting a user input in the haptic providing region, and providing a haptic effect corresponding to the haptic providing region in response to the detected user input, in which the haptic effect includes transformation of at least a portion of the haptic providing region.

According to another aspect of the present invention, a non-transitory machine-readable recording medium is provided, which stores a program for causing at least one processor to execute a method for providing a haptic effect in an electronic device, the method including displaying an application screen including a haptic providing region on a display; detecting a user input in the haptic providing region; and providing a haptic effect corresponding to the haptic providing region in response to the detected user input, wherein the haptic effect comprises transformation of at least a portion of the haptic providing region.

According to another aspect of the present disclosure, an electronic device is provided, including a display which senses input and outputs images; a haptic module; and a processor which controls the display to display an application screen comprising a haptic providing region; detects a user input on the haptic providing region; and controls the haptic module to provide a haptic effect corresponding to the haptic providing region in response to the detected user input, wherein the haptic effect comprises transformation of at least a portion of the haptic providing region.

### BRIEF DESCRIPTION OF THE DRAWINGS

The above and other aspects, features and advantages of certain embodiments of the present disclosure will be more apparent from the following detailed description taken in conjunction with the accompanying drawings, in which:

FIG. 1 illustrates a network environment including an electronic device according to various embodiments of the present disclosure;

FIG. 2 is a block diagram of an electronic device according to various embodiments of the present disclosure;

FIG. 3 is a block diagram of a programming module according to various embodiments of the present disclosure;

FIG. 4 is a diagram illustrating a display according to various embodiments of the present disclosure;

FIG. 5 is a diagram illustrating an input unit according to various embodiments of the present disclosure;

FIG. 6 is a flowchart illustrating a method for setting a local haptic environment according to various embodiments of the present disclosure;

FIGS. 7A through 7L illustrate a method for setting a local haptic environment according to various embodiments of the present disclosure;

FIGS. 8A through 15 are charts relating to various vibration patterns;

FIG. 16 is a diagram of a display according to various embodiments of the present disclosure;

FIGS. 17A through 18B are diagrams of a display using electro-osmosis, according to a various embodiments of the present disclosure;

FIGS. 19A through 21B are diagrams of displays using piezoelectric elements, according to various embodiments of the present disclosure;

FIGS. 22A and 22B illustrate a method for setting a local haptic environment according to various embodiments of the present disclosure;

FIG. 23 is a flowchart of a method for providing local haptic effects according to various embodiments of the present disclosure;

FIGS. 24A and 24B illustrate a method for providing local haptic effects according to various embodiments of the present disclosure;

FIG. 25 illustrates a method of setting a local haptic region according to various embodiments of the present disclosure;

FIG. 26 illustrates a method of setting a local haptic region according to various embodiments of the present disclosure;

FIGS. 27A and 27B illustrate a method for setting a local haptic region according to various embodiments of the present disclosure;

FIGS. 28A through 28C illustrate a method for providing a local haptic region according to various embodiments of the present disclosure;

FIGS. 29A through 29C are graphs illustrating how a vibration can provide guidance for a user to find a local haptic region, according to various embodiments of the present disclosure;

FIGS. 30A through 30C illustrate a method for setting and providing a local haptic region in an image according to various embodiments of the present disclosure;

FIG. 31A through 31C illustrate a method for setting and providing a local haptic region in a home screen according to various embodiments of the present disclosure;

FIG. 32 illustrates a method for providing a local haptic region for a call application according to various embodiments of the present disclosure; and

FIGS. 33A and 33B illustrate a method for providing a local haptic region according to various embodiments of the present disclosure.

### DETAILED DESCRIPTION

Embodiments of the present disclosure are described in detail with reference to the accompanying drawings, in which the same or similar reference numerals may refer to the same or similar components/elements. The present disclosure is not limited to the particular embodiments described herein, but should rather be construed as including all modifications, equivalents, and/or alternatives within its scope, as would be understood by one of ordinary skill in the art.

In the present disclosure, expressions such as “having,” “may have,” “comprising,” or “may comprise” are open-ended, and indicate there may be more than whatever is listed after the expression, whether the listed item(s) be, for example, a characteristic, an element, a numerical value, a function, an operation, or a component.

In the present disclosure, an expression such as “A or B,” “A/B,” “at least one of A and/or B,” or “one or more of A and/or B” may include all possible combinations of the listed items, depending on the context. For example, “A or B,” “at least one of A and B,” or “one or more of A or B” may include at least one A, at least one B, and both at least one A and at least one B.

Expressions such as “first,” “second,” “primarily,” or “secondary,” used in reference to embodiments may refer to various elements regardless of order and/or importance and do not limit corresponding elements in terms of order and/or importance. The expressions may be used merely for distinguishing one element from another element. For example, a first user device and a second user device may represent different user devices regardless of order or importance. Accordingly, for example, a first element may be referred to as a second element without deviating from the scope of the present disclosure, and similarly, a second element may be referred to as a first element.

When an element is described as “operatively or communicatively coupled” to or “connected” to another element, the element may be directly and/or indirectly connected to the other element, such as, for example, being connected through an intermediate element. However, when an element is described as “directly connected” or “directly coupled” to another element, it means that there is no intermediate element between the element and the other element.

The expression “configured to (or set)” as used in the present disclosure may be functionally/substantially equivalent with, for example, “suitable for,” “having the capacity to,” “designed to,” “adapted to,” “made to,” or “capable of” according to the situation/context. The term “configured to (or set)” does not always mean only “specifically designed to” by hardware. In some situations/contexts, the expression “apparatus configured to” may mean that the apparatus “can” operate in the described manner without be constructed specifically for that purpose. For example, “a processor configured (or set) to perform A, B, and C” may be a generic-purpose processor, such as a central processing unit (CPU) or an application processor (AP), that can perform A, B, and C, without being an exclusive and/or specific processor (such as an embedded processor) designed for performing A, B, and C.

Terms used for describing a specific embodiment are not intended to limit the scope of other embodiments. When used in the present disclosure and appended claims, a singular form of a word may also include the plural form unless it is explicitly limited to the singular form, and vice-versa. Technical and a scientific terms used herein may have the same and/or similar meaning as generally understood by a person of ordinary skill in the art. Terms should be interpreted in context, including the context of the related technology and are should not be limited and/or understood as having an ideal or excessively formal meaning unless explicitly defined as such in the present disclosure. Unless expressly indicated otherwise, terms used in the present disclosure cannot be interpreted and/or understood to exclude any of the embodiments.

An electronic device according to various embodiments of the present disclosure may be any one of a smart phone, a tablet Personal Computer (PC), a mobile phone, a video phone, an electronic book (e-book) reader, a desktop PC, a laptop PC, a netbook computer, a workstation, a server, a Personal Digital Assistant (PDA), a Portable Multimedia Player (PMP), an MP3 player, mobile medical equipment, a camera, and a wearable device. Wearable devices according to various embodiments of the present disclosure include all types, such as, for example, accessory types (e.g., a watch, a ring, a bracelet, an anklet, a necklace, glasses, contact lenses, or a Head-Mounted Device (HMD), a fabric or cloth-integrated type (e.g., an electronic cloth), a body-attached type (e.g., a skin pad or tattoo), and a body-implanted type (e.g., an implantable circuit).

According to various embodiments, the electronic device may be a home appliance, such as, for example, a Television (TV), a Digital Video Disk (DVD) player, audio equipment, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ or PlayStation™), an electronic dictionary, an electronic key, a camcorder, and an electronic frame.

According to various embodiments, the electronic device may be medical equipment (e.g., various portable medical measurement systems, such as a blood sugar measurement device, a heartbeat measurement device, a blood pressure measurement device, or a body temperature measurement device, Magnetic Resonance Angiography (MRA), Magnetic Resonance Imaging (MRI), Computed Tomography (CT), an imaging device, or an ultrasonic device), a navigation system, a Global Positioning System (GPS) receiver, an Event Data Recorder (EDR), a Flight Data Recorder (FDR), a vehicle infotainment device, electronic equipment for ships (e.g., navigation system and gyro compass for ships), avionics, a security device, a vehicle head unit, an industrial or home robot, an Automatic Teller Machine (ATM), a Point of Sale (POS) device, and/or any electronic device in the Internet of Things (e.g., electric bulbs, various sensors, electricity or gas meters, sprinkler devices, fire alarm devices, thermostats, streetlights, toasters, exercise machines, hot-water tanks, heaters, boilers, etc.).

According to various embodiments, the electronic device may be a part of a piece of furniture or building/structure, an electronic circuit board, an electronic signature receiving device, a projector, and any one of various measuring instruments (e.g., a water, electricity, gas, or electric wave measuring device). The electronic device according to various embodiments of the present disclosure may be r a combination of one or more of the above-listed examples. The electronic device according to various embodiments of the present disclosure may be a flexible device. As would be obvious to those of ordinary skill in the art, an electronic device according to various embodiments of the present disclosure is not limited to any of the above-listed examples and may include, for example, new and developing electronic devices.

Below, various embodiments of the present disclosure will be described with reference to the accompanying drawings. Herein, the term “user” may refer to a living entity who uses the electronic device or to a device which uses the electronic device (e.g., a robot, an physical avatar of a user, an intermediate device, and/or some form of an artificial intelligence embodied in an electronic device).

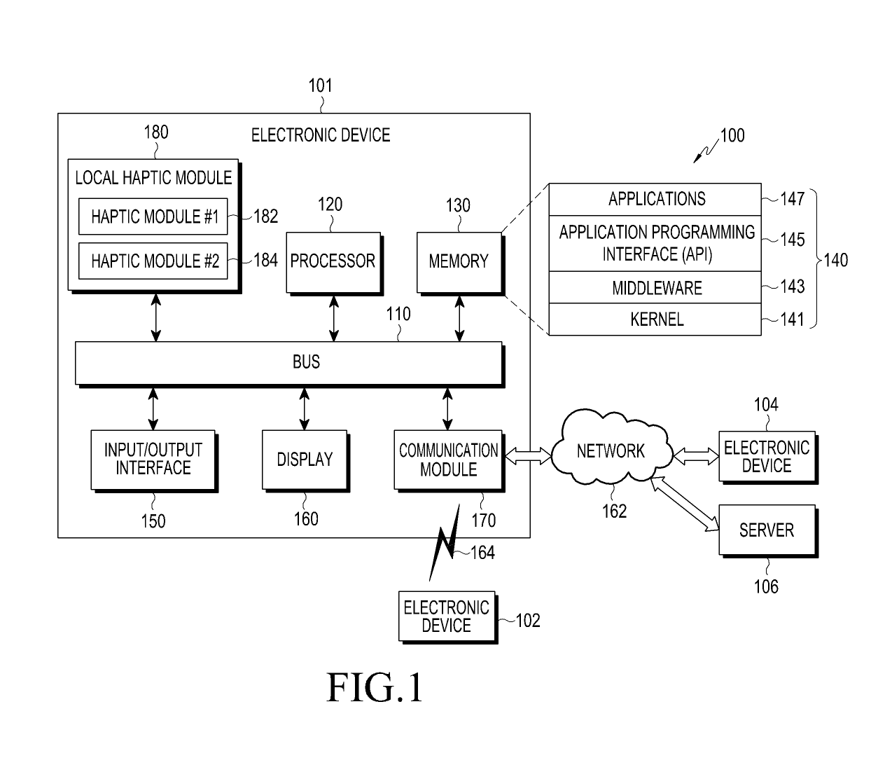

Referring to FIG. 1, a description will be made of an electronic device 101 in a network environment 100 according to various embodiments of the present disclosure. The electronic device 101 includes a bus 110, a processor 120, a memory 130, an input/output (I/O) interface 150, a display 160, a communication module 170, and a local haptic module 180. According to other embodiments, the electronic device may omit at least one of the foregoing elements or may further include other elements.

The bus 110 includes a circuit for interconnecting the elements 120, 130, 150, 160, 170, and 180 described above and for allowing communication (e.g., a control message and/or data) between the elements 120, 130, 150, 160, 170, and 180.

The processor 120 may include one or more of a Central Processing Unit (CPU), an Application Processor (AP), and/or a Communication Processor (CP). The processor 120 performs operations or data processing for control and/or communication of, for example, other components of the electronic device 101. The processor 120 may be referred to as a controller or may include a controller as a part thereof.

The memory 130 may include a volatile and/or nonvolatile memory. The memory 130 stores, for example, commands or data associated with at least one other elements of the electronic device 101. According to this embodiment, the memory 130 stores software/program 140. The program 140 includes a kernel 141, middleware 143, an Application Programming Interface (API) 145, and one or more applications/programs 147. Hereinafter, one or more applications/programs 147 may be referred to in the singular (e.g., an application) or plural, depending on the context. At least some of the kernel 141, the middleware 143, and the API 145 comprise the Operating System (OS).

The kernel 141 controls or manages, for example, system resources (e.g., the bus 110, the processor 120, or the memory 130) used to execute an operation or a function implemented in, e.g., the middleware 143, the API 145, or the one or more applications 147). The kernel 141 provides an interface through which the middleware 143, the API 145, or the application program 147 access separate components of the electronic device 101 to control or manage the system resources.

The middleware 143 works as an intermediary for allowing, for example, the API 145 or an application program 147 to exchange data with the kernel 141.

The middleware 143 processes and performs scheduling and/or load balancing of task requests. Middleware 143 processes one or more task requests received from an application program 147 according to priorities. For example, the middleware 143 may give a priority for using a system resource (e.g., the bus 110, the processor 120, or the memory 130) of the electronic device 101 to at least one of the application programs 147.

The API 145 is an interface used by an application 147 to control a function provided by the kernel 141 or the middleware 143, and may include, for example, at least one interface or function (e.g., a command) for file control, window control, image processing or character control.

The I/O interface 150 serves as an interface for delivering a command or data input from a user or external device to the electronic device 101. The I/O interface 150 may also output a command or data received from other element(s) of the electronic device 101 to a user or external device.

The display 160 may be, for example, a Liquid Crystal Display (LCD), a Light Emitting Diode (LED) display, an Organic Light Emitting Diode (OLED) display, a MicroElectroMechanical System (MEMS) display, or an electronic paper display. The display 160 displays various contents (e.g., a text, an image, video, an icon, or a symbol) to users. The display 160 may include a touch screen and thereby also operate as an input/output interface.

The communication module 170 sets up communication, for example, between the electronic device 101 and an external device (e.g., first external electronic device 102, second external electronic device 104, or server 106). In this embodiment, the communication module 170 is connected to network 162 through wireless or wired communication such that electronic device 101 can communicate with, e.g., the second external electronic device 104 or the server 106, through network 162. The communication module 170 may include a communication processor (CP) which may form one of a plurality of modules in the communication module 170. In some embodiments, the CP may be included in the processor 120.

The wireless communication used as a cellular communication protocol may be, for example, at least one of long term evolution (LTE), LTE-advanced (LTE-A), code division multiple access (CDMA), wideband CDMA (WCDMA), a universal mobile telecommunication system (UMTS), wireless broadband (WiBro), or global system for mobile communications (GSM)). The wireless communication includes short-range communication 164. The short-range communication may be any one or more of Wireless Fidelity (WiFi), Bluetooth, and/or near field communication (NFC). The wireless communication may include, for example, a global navigation satellite system (GNSS) receiver. The GNSS may be, for example, any one or more of the Global Positioning System (GPS), the Russian global navigation satellite system (GLONASS), the Chinese navigation satellite system (Beidou), and the European global satellite-based navigation system (Galileo), depending on use area or bandwidth. Hereinafter, in the present document, “GPS” and “GNSS” may be used interchangeably. The wired communication may include, for example, at least one of a universal serial bus (USB), a high definition multimedia interface (HDMI), a recommended standard, such as (RS)-2032, and plain old telephone service (POTS). The network 162 may be a telecommunications network, for example, at least one of a computer network (e.g., a local area network (LAN) or a wide area network (WAN)), Internet, and a telephone network.

The local haptic module 180 includes a first haptic module 182 and a second haptic module 184. The first haptic module 182 generates vibration under control of the processor 120. The second haptic module 184 changes or transforms a local haptic region, which is a region of the display 160, under control of the processor 120.

The processor 120 senses a user input, such as hovering, as an user input unit approaches the display 160 or is located in proximity to the display 160. The processor 120 may provide a preset haptic effect corresponding to a user input, if the user input is generated for a preset region or graphic element of the display 160 or is generated in a preset manner.

The graphic element corresponding to the local haptic region on display 160 may be at least one of an object for which a region may be set by a user, a function item, an icon, a menu, an application, a document, a widget, a picture, a video, an e-mail, a short messaging service (SMS) message, a multimedia messaging service (MMS) message, and/or the like.

To provide a haptic effect, the processor 120 outputs a control signal to the local haptic module 180 (which may be fully or partially integrated into I/O interface 150 and/or display 160). The control signal may include information about ahaptic feedback/effect, that is, haptic information (e.g., a kind or type of vibration pattern, a kind or type of transformation of the shape of the local haptic region, and/or the like), and the local haptic module 180 generates a haptic feedback/effect (e.g., vibration, transformation of a local haptic region, or the like) corresponding to the haptic information. The haptic information may indicate a pattern or a form/shape, or an identifier thereof. The control signal may simply be a request for generation of the haptic feedback/effect.

Each of the first external electronic device 102 and the second external electronic device 104 may be of the same or different type than the electronic device 101. According to an embodiment of the present disclosure, the server 106 includes a group of one or more servers. According to various embodiments, all or some of operations performed in the electronic device 101 may be performed in another electronic device or a plurality of electronic devices (e.g., the electronic devices 102 and 104 or the server 106). According to an embodiment of the present disclosure, when the electronic device 101 has to perform a function or a service automatically or at the user's request, the electronic device 101 may request another device (e.g., the electronic devices 102 and 104 or the server 106) to perform at least some functions associated with the function or the service instead of or in addition to executing the function or the service. The other electronic device may perform the requested function or additional function and deliver the result to the electronic device 101. The electronic device 101 provides the received result or provides the requested function or service by processing the received result. To this end, for example, cloud computing, distributed computing, or client-server computing may be used.

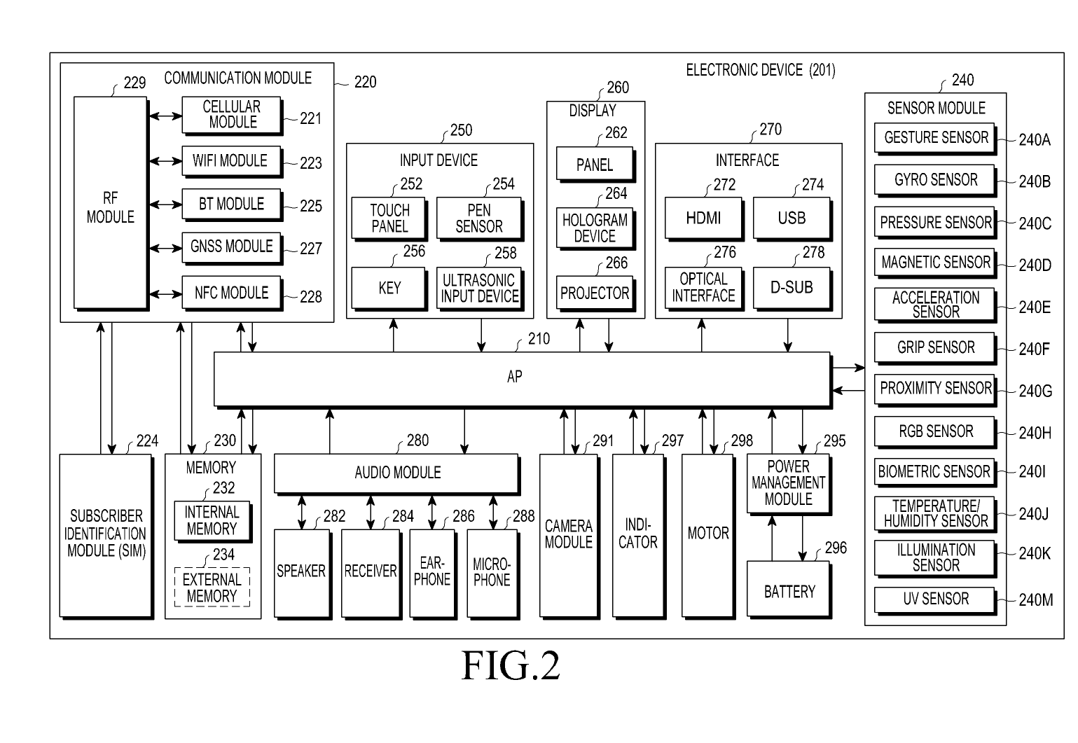

FIG. 2 is a block diagram of an electronic device 201 according to various embodiments of the present disclosure. Parts of the electronic device 101 illustrated in FIG. 1 may or may not overlap with parts of electronic device 201 illustrated in FIG. 2.

The electronic device 201 includes one or more application processors (designated “AP” in FIG. 2) 210, a communication module 220, a memory 230, a sensor module 240, an input device 250, a display 260, a subscriber identification module (SIM) 224, an interface 270, an audio module 280, a camera module 291, a power management module 295, a battery 296, an indicator 297, and a motor 298. The electronic device 201 may also include a haptic module like the local haptic module 180 illustrated in FIG. 1.

The application processor (AP) 210 controls multiple hardware or software components connected to AP 210 by driving an operating system (OS) or an application program, and performs processing and operations with respect to various data including multimedia data. The AP 210 may be implemented with, for example, a system on chip (SoC). According to an embodiment, the AP 210 may further include a graphic processing unit (GPU) and/or an image signal processor. The AP 210 may include at least a part of other elements illustrated in FIG. 2 (e.g., the cellular module 221). The AP 210 loads a command or data received from at least one of other elements (e.g., a non-volatile memory) into a volatile memory and processes the command or data and stores various data in the non-volatile memory.

The communication module 220 may have a configuration that is the same as or similar to the communication module 170 illustrated in FIG. 1. The communication module 220 includes cellular module 221, a WiFi module 223, a Bluetooth (BT) module 225, a GNSS module 227 (e.g., a GPS module, a GLONASS module, Beidou module, or a Galileo module), an NFC module 228, and a radio frequency (RF) module 229.

The cellular module 221 may provide, for example, a voice call, a video call, a text service, or an Internet service over a communication network. The cellular module 221 may identify and authenticate the electronic device 201 in a communication network by using the SIM 224. The cellular module 221 may perform a function provided by the AP 210. According to an embodiment, the cellular module 221 may include a communication processor (CP).

At least one of the WiFi module 223, the BT module 225, the GNSS module 227, and the NFC module 228 may include its own processor for processing its own transmitted and/o received data. According to some embodiments, two or more of the cellular module 221, the WiFi module 223, the BT module 225, the GNSS module 227, and the NFC module 228 may be included in one Integrated Chip (IC) or IC package.

The RF module 229 transmits and receives a communication signal (e.g., an RF signal). The RF module 229 may include a transceiver, a power amp module (PAM), a frequency filter, a low noise amplifier (LNA), or an antenna. Depending on the embodiment, at least one of the cellular module 221, the WiFi module 223, the BT module 225, the GNSS module 227, and the NFC module 228 may transmit and receive their respective RF signals through RF module 229 or through a separate RF module.

The SIM 224 includes a card including an SIM and/or an embedded SIM, and may include unique identification information (e.g., an integrated circuit card identifier (ICCID) or subscriber information (e.g., an international mobile subscriber identity (IMSI)).

The memory 230 includes an internal memory 232 and possibly an external memory 234. The internal memory 232 may include at least one of a volatile memory (e.g., dynamic random access memory (DRAM), static RAM (SRAM), synchronous dynamic RAM (SDRAM), and a non-volatile memory (e.g., one time programmable read only memory (OTPROM), programmable ROM (PROM), erasable and programmable ROM (EPROM), electrically erasable and programmable ROM (EEPROM), mask ROM, flash ROM, a flash memory (e.g., a NAND flash memory or NOR flash memory), a hard drive, and a solid state drive (SSD). The external memory 234 may be a flash drive (for example, compact flash (CF)), secure digital (SD), micro-SD, mini-SD, extreme Digital (xD), a MultiMedia Card (MMC), or a memory stick. The external memory 234 may be functionally and/or physically connected with the electronic device 201 through various interfaces.

The sensor module 240 measures physical conditions and/or senses an operation state of the electronic device 201. The sensor module 240 includes a gesture sensor 240A, a gyro sensor 240B, a pressure sensor 240C, a magnetic sensor 240D, an acceleration sensor 240E, a grip sensor 240F, a proximity sensor 240G, a color sensor 240H (e.g., RGB sensor), a biometric sensor 240I, a temperature/humidity sensor 240J, an illumination sensor 240K, and a ultraviolet (UV) sensor 240M. Additionally or alternatively, the sensor module 240 may include an e-nose sensor, an electromyography (EMG) sensor, an electroencephalogram (EEG) sensor, an electrocardiogram (ECG) sensor, or a fingerprint sensor. The sensor module 240 may further include a control circuit for controlling at least one sensor included therein. In some embodiments, the electronic device 201 may further include a processor configured to control the sensor module 240 as part of or separately from AP 210, to control the sensor module 240 during a sleep state of AP 210.

The input device 250 includes a touch panel 252, a (digital) pen sensor 254, a key 256, and an ultrasonic input device 258. The touch panel 252 may be a capacitive type, a resistive type, an IR type, and/or an ultrasonic type. The touch panel 252 may further include a control circuit and a tactile layer to provide tactile reaction to the user.

The (digital) pen sensor 254 may be a recognition sheet which is a part of the touch panel 252 or a separate recognition sheet. The key 256 may be a physical button, an optical key, or a keypad. The ultrasonic input device 258 senses ultrasonic waves generated in an input means for generating the ultrasonic waves through the microphone 288 and checks data corresponding to the sensed ultrasonic waves in the electronic device 201.

The display 260 includes a panel 262, a hologram device 264, and a projector 266. The panel 262 may have a configuration that is the same as or similar to that of the display 160 of FIG. 1. The panel 262 may be flexible, transparent, or wearable. The panel 262 may be configured with the touch panel 252 in one module. The hologram device 264 shows a stereoscopic image in the air by using interference of light. The projector 266 displays an image externally through a projection of light. According to an embodiment, the display 260 may further include a control circuit for controlling the panel 262, the hologram device 264, or the projector 266.

The interface 270 includes a high-definition multimedia interface (HDMI) 272, a universal serial bus (USB) 274, an optical communication interface 276, and a D-subminiature (D-SUB) 278. In certain embodiments, such interfaces may be included in the communication module 170 illustrated in FIG. 1. Additionally or alternatively, the interface 270 may include a Mobile High-Definition Link (MHL) interface, an SD/MMC interface, or an infrared data association (IrDA) interface.

The audio module 280 converts sound into an electric signal and vice-versa. In certain embodiments, elements of audio module 280 may be included in the I/O interface 150 illustrated in FIG. 1. The audio module 280 processes sound information input or output through the speaker 282, the receiver (i.e., a listening device part of the electronic device 201) 284, the earphone 286, or the microphone 288.

The camera module 291 is capable of capturing still or moving images, and, depending on the embodiment, may include one or more image sensors (e.g., a front sensor or a rear sensor), a lens, an image signal processor (ISP), or a flash (e.g., an LED or a xenon lamp).

The power management module 295 manages power of the electronic device 201. According to various embodiments, the power management module 295 may include a Power management integrated circuit (PMIC), a charger IC, or a battery gauge. The PMIC may have a wired and/or wireless charging scheme. The wireless charging scheme may be a magnetic-resonance type, a magnetic induction type, and an electromagnetic type, and for wireless charging, an additional circuit, for example, a coil loop, a resonance circuit, or a rectifier may be further included. The battery gauge measures the remaining capacity of the battery 296 or the voltage, current, or temperature of the battery 296 during charging. The battery 296 may be a rechargeable battery and/or a solar battery.

The indicator 297 displays the current state, for example, booting, messaging, or charging, of the electronic device 201 or a part thereof (e.g., the AP 210). The motor 298 (which, in certain embodiments, may operate similarly to the first haptic module 182 in FIG. 1) converts an electric signal into mechanical vibration or generates vibration or a haptic effect. Although not shown, the electronic device 201 may include a processing device, e.g., a general processing unit (GPU), for supporting a mobile TV. The processing device for supporting the mobile TV processes media data according to a standard such as, for example, digital multimedia broadcasting (DMB), digital video broadcasting (DVB), or mediaFlo™.

Each of the foregoing described elements may include one or more components, and a name of any element or part may vary with the type of electronic device. Electronic devices according to the present disclosure may have more or less of the foregoing described elements/components, depending on the implementation. Depending on the embodiment, functions performed by one of the foregoing described components/elements may be divided up among a number of components/elements, or various functions performed by several of the foregoing described components/elements may be combined and performed by a single component/element.

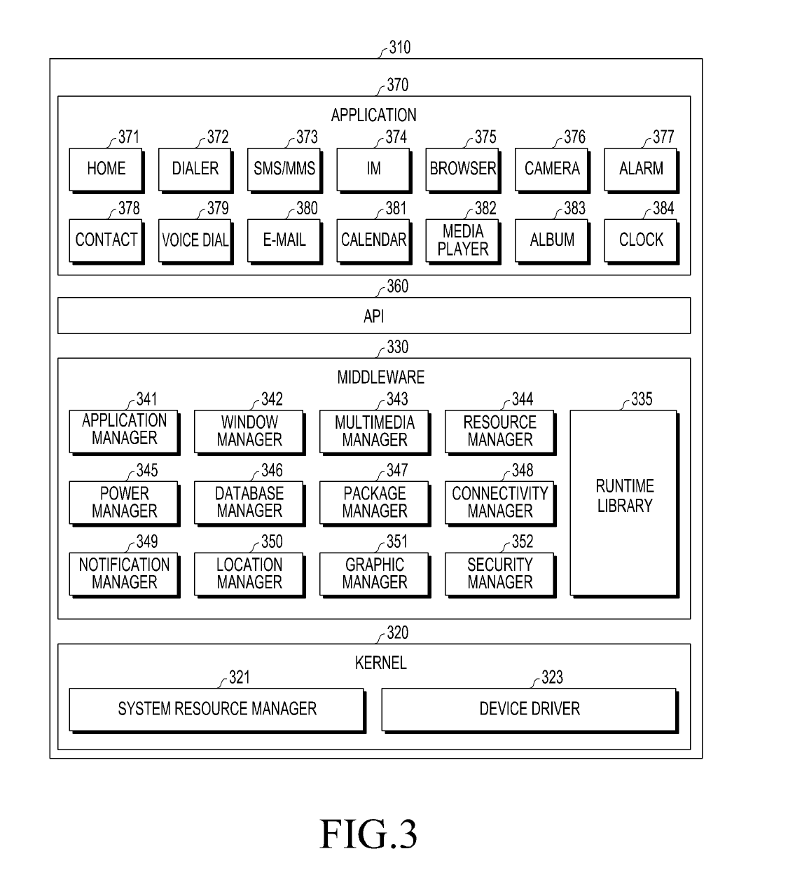

FIG. 3 is a block diagram of a programming module according to various embodiments of the present disclosure. The programming module 310 in FIG. 3 is a component/module similar in form and function to the software/program 140 in FIG. 1. Like software/program 140, programming module 310 may include an OS for controlling resources associated with the electronic device and/or various applications executed on the OS. The OS may be Android, iOS, Windows, Symbian, Tizen, or Bada.

The programming module 310 includes kernel 320, middleware 330, an application programming interface (API) 360, and applications 370. At least a part of the programming module 310 may be preloaded or may be downloaded from an external electronic device.

The kernel 320 includes a system resource manager 321 and a device driver 323. The system resource manager 321 performs control, allocation, and/or retrieval of system resources. The system resource manager 321 may include a process management unit, a memory management unit, or a file system. The device driver 323 may include, for example, a display driver, a camera driver, a Bluetooth driver, a shared memory driver, a USB driver, a keypad driver, a WiFi driver, an audio driver, or an inter-process communication (IPC) driver.

The middleware 330 provides various functions to the applications 370 through the API 360 to allow the applications 370 to efficiently use the limited system resources of the electronic device. Middleware 330 includes a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 is a library that a compiler uses to add a new function through a programming language while applications 370 are executed. The runtime library 335 performs functions relating to an I/O, memory management, or calculation operation.

The application manager 341 manages a life cycle of at least one application among the applications 370. The window manager 342 manages a graphical user interface (GUI) resource using a screen. The multimedia manager 343 recognizes a format necessary for playing various media files and performs encoding or decoding on a media file by using a codec appropriate for a corresponding format. The resource manager 344 manages a resource such as source code, memory, or storage space of at least one application among the applications 370.

The power manager 345 manages a battery or power in operation with a basic input/output system (BIOS) and provides power information necessary for operation of the electronic device. The database manager 346 performs management operations to generate, search or change at least one database used for at least one application among the applications 370. The package manager 347 manages the installation or update of an application distributed in a package file format.

The connectivity manager 348 manages a wireless connection such as a WiFi or Bluetooth connection. The notification manager 349 notifies the user of events such as arrival messages, appointments, and proximity alerts in a manner that is not disruptive to a user. The location manager 350 manages location information of the electronic device. The graphic manager 351 manages a graphic effect to be provided to a user through a user interface (UI) related thereto. The security manager 352 provides a general security function necessary for system security or user authentication. When the electronic device has a call function, the middleware 330 may further include a telephony manager for managing a voice or video call function of the electronic device.

The middleware 330 may include a middleware module forming a combination of various functions of the above-mentioned internal elements. The middleware 330 may provide modules specified according to types of OS so as to provide distinctive functions. Additionally, the middleware 330 may dynamically add or delete some of the elements.

The API 360 may be provided as a set of API programming functions with a different configuration according to the OS. In the case of Android or iOS, for example, one API set may be provided by each platform, and in the case of Tizen, two or more API sets may be provided.

Applications 370 includes one or more applications capable of providing a function, including a home application 371, a dialer application 372, a short messaging service/multimedia messaging service (SMS/MMS) application 373, an instant messaging (IM) application 374, a browser application 375, a camera application 376, an alarm application 377, a contact application 378, a voice dial application 379, an e-mail application 380, a calendar application 381, a media player application 382, an album application 383, and a clock application 384. Applications 370 may also include a health care application (e.g., an application for measuring an exercise amount or a blood sugar level), or an environment information providing application (e.g., an application for providing air pressure, humidity, or temperature information).

Applications 370 may include an application (hereinafter, an “information exchange application” for convenience) supporting information exchange between the electronic device and one or more external electronic devices (such as, e.g., electronic devices 102 or 104 in FIG. 1). The information exchange application may include, for example, a notification relay application for transferring specific information to an external electronic device or a device management application for managing an external electronic device.

The notification relay application may include a function for transferring notification information generated in another application (e.g., an SMS/MMS application, an e-mail application, a health care application, or an environment information application) of the electronic device to one or more external electronic devices. The notification relay application may receive notification information from an external electronic device to provide the same to a user.

The device management application may manage (e.g., install, remove, or update) at least one function (e.g., turning on/off an external electronic device or a part thereof or controlling the brightness or resolution of its display) or service provided by an external electronic device (e.g., a call service or a message service).

Applications 370 may include an application (e.g., a health care application) designated according to an attribute of an external electronic device (e.g., a type of the electronic device being mobile medical equipment as the attribute of the electronic device). Applications 370 may include an application received from the external electronic device, a preloaded application or a third party application that may be downloaded from a server. Names of the elements/components of a programming module according to various embodiments may vary depending on the type of OS.

According to various embodiments, at least a part of the programming module may be implemented by software, firmware, hardware, or a combination of at least two of them. At least a part of the programming module may be implemented (e.g., executed) by a processor. The programming module may include a module, a program, a routine, sets of instructions, or a process for performing one or more functions.

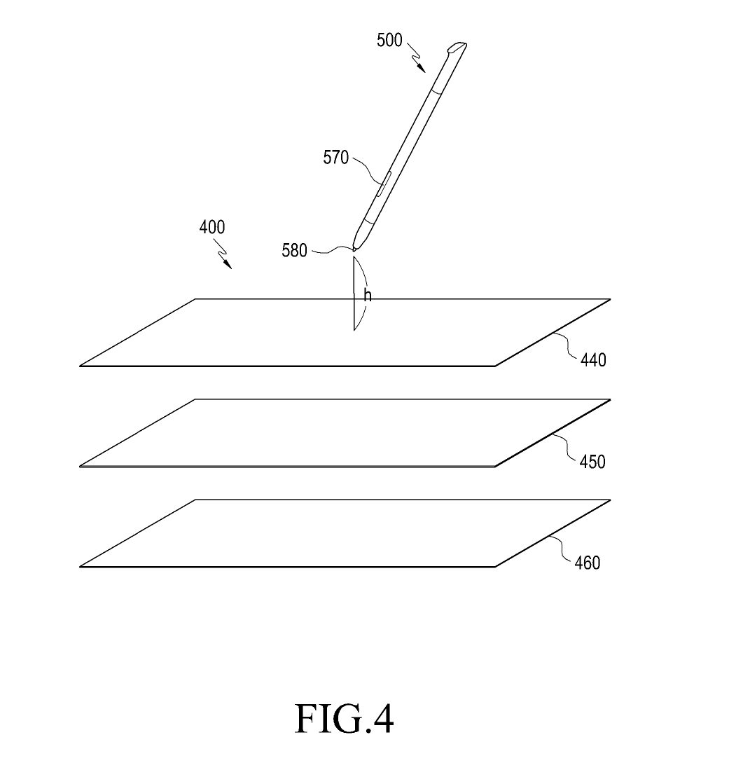

FIG. 4 illustrates a display according to various embodiments of the present disclosure.

Referring to FIG. 4, a display 400 (which may be an implementation of, e.g., display 160 or 260) includes a first touch panel 440 for sensing a finger input, a display panel 450 for screen display, and a second touch panel 460 for sensing a pen input. The panels are sequentially disposed from top to bottom by closely contacting, or being at least partially spaced apart from, one another. The first touch panel 440 may also be disposed under the display panel 450.

The display panel 450 includes multiple pixels and displays an image through these pixels. For the display panel 450, a Liquid Crystal Display (LCD), an Organic Light Emitting Diode (OLED), or an LED may be used. The display panel 450 displays various operation states of the electronic device, various images corresponding to execution of applications or services, and a plurality of objects.

The first touch panel 440 may include a window exposed on the front surface of the electronic device and a sensor layer attached to a bottom surface of the window to recognize information (e.g., position, strength, or the like) of the finger input. The sensor layer forms a sensor for recognizing a position of a finger contact on the surface of the window, and to this end, the sensor layer has preset patterns. The sensor layer may have various patterns such as, for example, a linear latticed pattern, a diamond-shape pattern, and/or the like. To perform a sensor function, a scan signal having a preset waveform is applied to the sensor layer, and if the finger contacts the surface of the window, a sensing signal whose waveform is changed by a capacitance between the sensor layer and the finger is generated. A processor analyzes the sensing signal, thereby recognizing whether and where the finger contacts the surface of the window.

The first touch panel 440 may be manufactured by first coating a thin metallic conductive material (for example, an Indium Tin Oxide (ITO) layer, or the like) onto both surfaces of the window to allow electric current to flow on the surface of the window and then coating a dielectric, which is capable of storing electric charges, onto the coated surfaces. Once the finger touches the surface of the first touch panel 440, a predetermined amount of electric charges moves to the touched position by static electricity, and the first touch panel 440 recognizes the amount of change of current corresponding to movement of the electric charges, thus sensing the touched position.

Any type of contact capable of generating static electricity may be sensed through the first touch panel 440.

The second touch panel 460 is an Electromagnetic Resonance (EMR) touch panel, and may include an electromagnetic induction coil sensor having a grid structure in which a plurality of loop coils intersect one another and an electronic signal processor for sequentially providing an alternating current signal having a predetermined frequency to the respective loop coils of the electromagnetic induction coil sensor. If an input unit 500, such as a stylus pen, having a resonance circuit embedded therein is brought near the loop coil of the second touch panel 460, a signal transmitted from the loop coil generates electric current based on mutual electromagnetic induction in the resonance circuit of the input unit 500. Based on the electric current, the resonance circuit of the input unit 500 generates and outputs an induction signal. Then, the second touch panel 460 detects the induction signal by using the loop coil, thus sensing an input position (i.e., a hovering input position or a direct touch position) of the input unit 500. The second touch panel 460 may also sense a height h from the surface of the display 400 to a pen point 580 of the input unit 500. The induction signal output from the input unit 500 may have a frequency which varies according to a pressure applied by the input unit 500 to the surface of the display 400. Based on the frequency, the pressure (i.e., a pen pressure) of the input unit 500 may be sensed.

An input means capable of generating electric current based on electromagnetic induction may be sensed through the second touch panel 460.

FIG. 5 illustrates an input unit according to various embodiments of the present disclosure.

Referring to FIG. 5, the input unit 500 (for example, a touch pen) includes a) the pen point 580, b) a button 570 capable of changing an electromagnetic induction value generated by a coil 510 disposed inside the penholder adjacent to the pen point 580, c) a vibration element 520, d) a haptic controller 530 for analyzing a control signal received from the electronic device and controlling vibration strength and interval of the vibration element 520 to provide a haptic effect corresponding to the analysis result to the input unit 500, e) a short-range communication unit 540 for performing short-range communication with the electronic device, and f) a battery 550 for supplying power for vibration of the input unit 500. The input unit 500 also includes a speaker 560 for outputting sound corresponding to vibration interval and/or vibration strength of the input unit 500. The speaker 560 may output sound corresponding to the haptic effect provided to the input unit 500 together with a speaker included in the electronic device (such as, e.g., the speaker 282 in FIG. 2), simultaneously with or a predetermined time (for example, 10 ms) before/after the haptic effect.

More specifically, the speaker 560 outputs sound corresponding to various signals (for example, a wireless signal, a broadcast signal, a digital audio file, or a digital moving image file) received from a communication device (such as, e.g., the communication module 170 in FIG. 1 or the communication module 220 in FIG. 2) provided in the electronic device under control of the haptic controller 530. The speaker 560 outputs sound (for example, button manipulation sound or a ring back tone corresponding to a phone call) corresponding to a function executed by the electronic device, and one or more of speakers may be formed in predetermined areas of a housing of the input unit 500.

When the pen point 580 contacts the display or is placed in a position (for example, within 5 mm) of a display which senses hovering, then the haptic controller 530 analyzes at least one control signal received from the electronic device through the short-range communication unit 540 and controls the vibration interval and strength of the vibration element 520 provided in the input unit 500 according to the analyzed control signals. The short-range communication unit 540 for receiving the control signals has already been activated prior to reception of the control signals. The control signal is transmitted by the electronic device and may be transmitted to the input unit 500 repetitively at predetermined intervals (for example, every 5 ms). That is, when the pen point 580 contacts the display 400, the electronic device recognizes the object (or icon) which is pointed to by the pen point 580 on the display 400 and transmits a control signal generated according to a haptic type/pattern assigned to the object (or icon) to the short-range communication unit 540 provided in the input unit 500.

The control signal may be transmitted to the input unit 500 by a communication device of the electronic device. The control signal includes at least one of information for activating the vibration element 520 of the input unit 500, information indicating vibration strength of the input unit 500, information for deactivating the vibration element 520 of the input unit 500, and information indicating a total time during which the haptic effect is provided. The control signal has a predetermined size of, for example, about 8 bits, and is repetitively transmitted at predetermined intervals (for example, 5 ms) to control vibration of the input unit 500, such that the user may recognize that the vibration corresponding to the haptic effect is repetitively generated at predetermined intervals. For example, the control signal may include information provided in Table 1.

TABLE 1

| | Vibration | | | | | | Vibration |
|---|---|---|---|---|---|---|---|
| | Element | Vibration | | | | | Element |
| Field | Activation | Strength | | | | | Deactivation |
| Information | 1 | 125 | 125 | 131 | 131 | 0 | 2 |

In Table 1, the control signal includes information (for example, a predetermined value such as 1) for activating the vibration element 520 of the input unit 500, information indicating vibration strength of the vibration element 520, and information (for example, a predetermined value such as 2) for deactivating the vibration element 520. The control signal may be transmitted to the input unit 500 every 5 ms, but this is merely an example and a timing of the transmission of the control signal may be variable according to an interval of the haptic type/pattern. In addition, transmission interval and transmission period of the control signal may also be variable. The transmission period may last until a temporary touch or a continuous touch of the input unit 500 on the display 400 is terminated.

The input unit 500, structured as described above, supports an electromagnetic induction scheme. If a magnetic field is formed in a predetermined position of the display 400 by the coil 510, the display 400 detects a corresponding magnetic field position and recognizes a touch position. If the pen point 580 is adjacent to or touches the display 400 resulting in a user input event, the electronic device identifies an object corresponding to a user input position and transmits a control signal indicating a haptic type/pattern, which is preset in the identified object, to the input unit 500.

A method is provided for a user to set a local haptic effect in a region or object of an application among various applications and display screens (including the home screen) provided by the electronic device. The “local haptic effect” refers to a vibration or a three-dimensional (3D) tactile sense that is provided for a region of a screen.

By using local haptic effects, a user may easily select a desired object without viewing the screen.

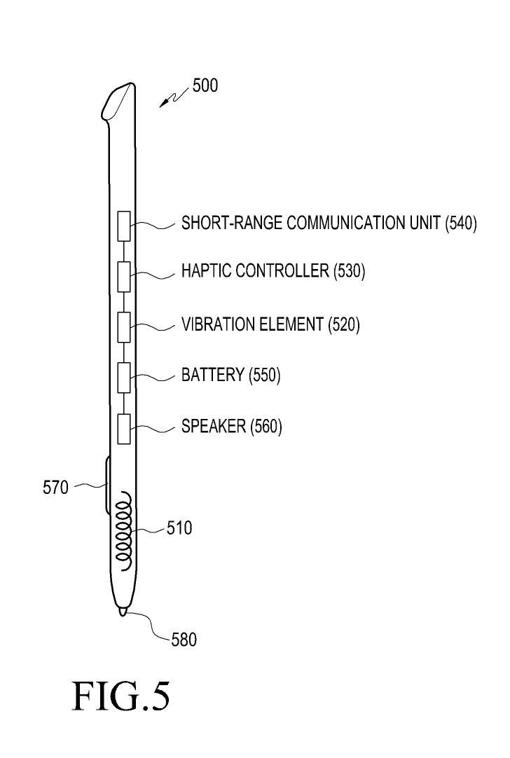

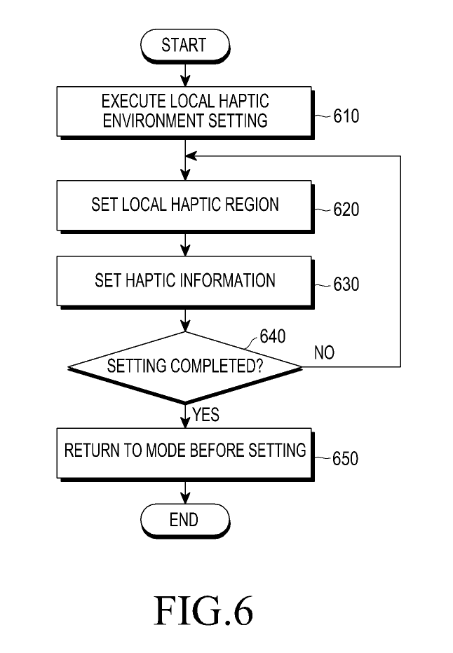

FIG. 6 is a flowchart for illustrating a method for setting a local haptic environment according to various embodiments of the present disclosure.

In step 610, a processor (such as, e.g., the processor 120 of FIG. 1 or AP 210 of FIG. 2) of the electronic device executes the local haptic environment setting automatically or at the request of a user. The user may set a local haptic condition and effect by selecting and executing the local haptic environment setting.

In step 620, the processor sets a local haptic region according to the user's selection. The user may select a local haptic region (that is, a haptic providing area) in a screen of an application in which a local haptic effect is to be provided.

In step 630, the processor sets haptic information (e.g., the type of vibration pattern, the type of transformation or deformation of the surface of the local haptic region, or the like) according to user's selection. The user may determine the haptic information to be applied to the local haptic region.

In step 640, the processor determines whether the local haptic environment setting has been completed or terminated. The processor determines whether user's local haptic environment setting has been completed. If the local haptic environment setting has been completed, the processor returns in step 450 to the mode before setting the local haptic environment setting mode in step 610. If the local haptic environment setting has not been completed, the processor returns to step 620 to set the local haptic region.

Execution of the local haptic environment setting may be implemented in various ways.

The electronic device illustrated in the following drawings may have some of the same structure and functionality as the electronic devices illustrated in FIG. 1 or 2, although not necessarily.

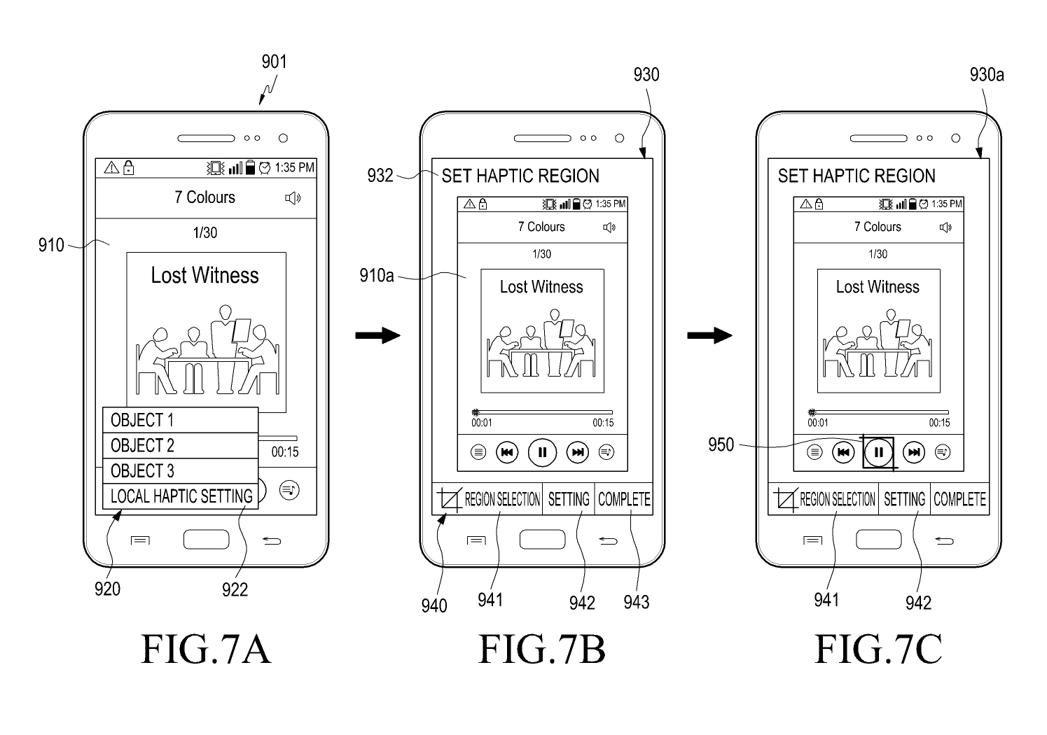

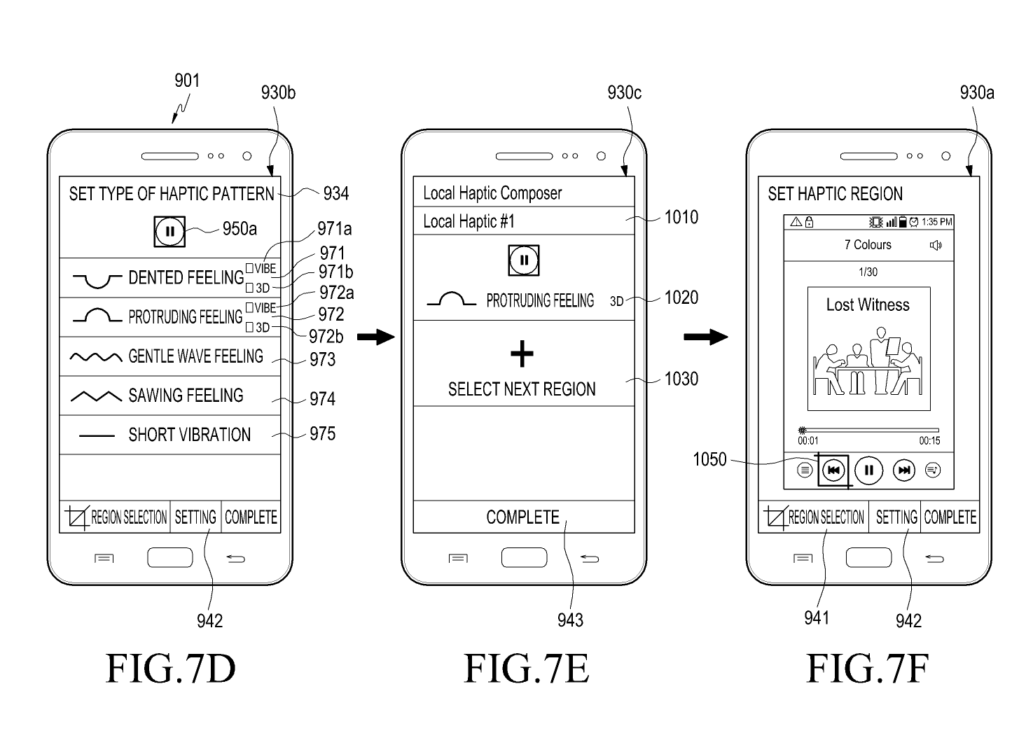

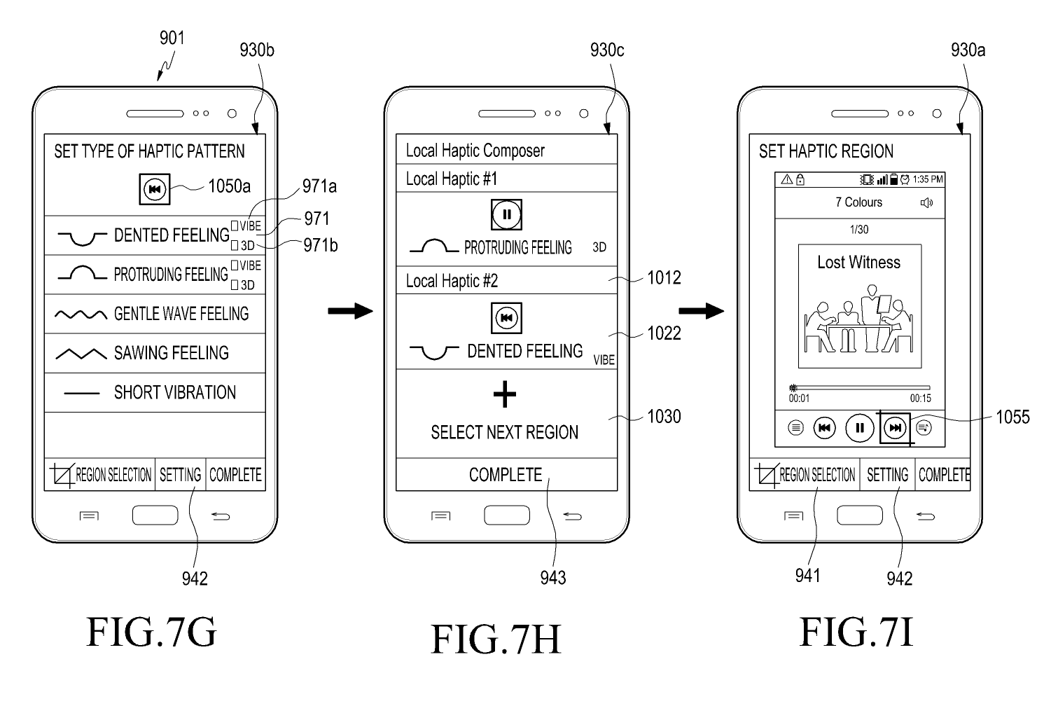

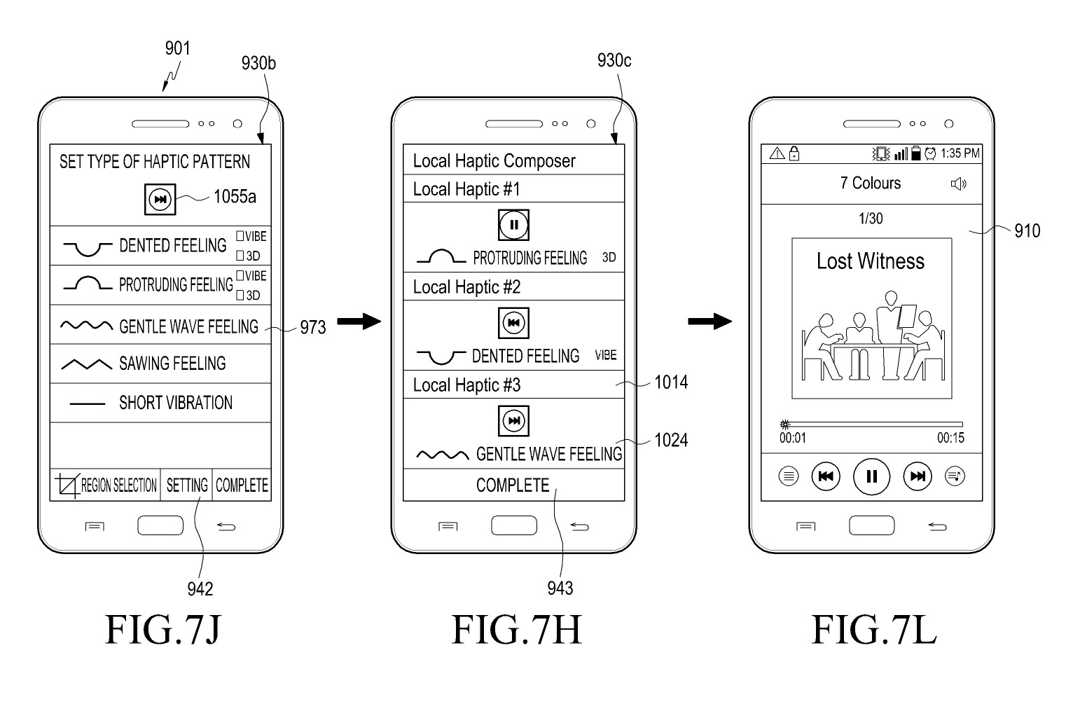

FIGS. 7A through 7L are diagrams illustrating a method for setting a local haptic environment according to various embodiments of the present disclosure.

Referring to FIG. 7A, the processor of the electronic device 901 displays a music/video application screen 910 and provides a user input for selecting local haptic environment setting 922 in environment setting menu 920 displayed on the music/video application screen 910.

Upon selection by the user of the local haptic environment setting 922, a local haptic environment setting screen 930 is displayed as illustrated in FIG. 7B. The local haptic environment setting screen 930 displays a representative image 910a of the music/video application in a size-reduced form. The local haptic environment setting screen 930 also displays a phrase 932 indicating the selection of the local haptic region such as, in this example, the sentence stating “SET HAPTIC REGION”, and local haptic environment setting menu 940. The environment setting menu 940 includes a region selection button 941 for the user's designation of a local haptic region, a setting button 942 for completion of a selection of the local haptic region, and a complete button 943 for completing the local haptic environment setting. Hereinafter, although “button” is used for convenience, the graphic object to be selected may be any of, for example, an icon, an image, text, etc. As discussed below, the user may designate a start position and an end position of the local haptic region, thus selecting the local haptic region, when performing region selection after selecting button 941. The representative image 910a has been previously stored in a memory of the electronic device 901.

In FIG. 7C, the user has selected the region selection button 941 in the environment setting menu 940 and is now setting the desired region or graphic element. More specifically, the user sets the pause/play button to as the first local haptic region 950 in haptic region setting screen 930a. Thereafter, the user selects the setting button 942 in the environment setting menu 940 in order to execute a haptic information/type setting operation corresponding to the selected first local haptic region 950.

Generally speaking, the local haptic region may be mapped to an object (or a graphic element) such as a menu, an icon, or the like. The local haptic region may be larger, smaller, or to the same size as an area occupied by an object. The local haptic region may be positioned on a circumference of an object or may at least partially overlap with the object. For example, if the local haptic region has a quadrilateral shape, the coordinates of diagonal corners of the first local haptic region (i.e., (x1, y1) and (x2, y2) coordinates) may be stored in the memory. The local haptic region may have the shape of a quadrilateral, a triangle, a circle, and/or an oval, and coordinates which define these various shapes may be stored in the memory. The local haptic region may have a size which is the same as or different from that of a graphic element (or a function item). For example, if a graphic element is an icon, the local haptic region may be larger or smaller than the icon. Also, the local haptic region may be set in a screen, such as, e.g., a home screen, generated by an Operating System (OS), as well as an application such as a music/video application.

In FIG. 7D, upon detection of the user input on the setting button 942, a haptic type setting screen 930b is displayed. An image 950a, based on the first local haptic region 950 selected by the user, together with the guide phrase 934 “SET TYPE OF HAPTIC PATTERN”, is displayed on the haptic type setting screen 930b. Selectable first through fifth haptic types/patterns 971, 972, 973, 974, and 975 are also displayed on the haptic type setting screen 930b, by which the user may select the haptic type/pattern for the first local haptic region 950. Each haptic type may be indicated as an image indicating a change of vibration strength or waveform over time and a text describing the haptic type. Furthermore, options may be displayed with the various haptic types. For example, in FIG. 7D, the first haptic type 971 has a vibration option 971a and a 3D option 971b which may be additionally set, and the second haptic type 972 has a vibration option 972a and a 3D option 972b which may be additionally set. Accordingly, if the vibration option 971a or 972a is set, a vibration effect is provided and if the 3D option 971b or 972b is set, a 3D transformation effect is provided.

In FIG. 7D, the user selects second haptic type 972 (“PROTRUDING FEELING”) and the 3D option 972b, and then presses setting button 942.

In FIG. 7E, the local haptic environment setting confirm screen 930c is displayed to the user as a result of the user selecting the setting button 942 in FIG. 7D to set the selected haptic type to be applied to the selected local haptic region. On the local haptic environment setting confirm screen 930c, the user-set local haptic effect details are arranged and displayed. Thus, in FIG. 7E, first local haptic effect information 1010 (“Local Haptic #1”) presents information 1020 indicating that the second haptic type (“PROTRUDING FEELING”) with the three-dimensional feeling option is being assigned to the first local haptic region 950 (i.e., the pause/play button in the music/video application screen 910).

On the local haptic environment setting confirm screen 930c, the user may either complete the haptic setting operation by selecting COMPLETE button 943 or continue the haptic setting operation by selecting button 1030 (“SELECT NEXT REGION”) for setting the next local haptic region.

If the user selects button 1030 for setting a next local haptic region, the local haptic environment setting screen 930a is again displayed, as illustrated in FIG. 7F.

Similar to FIG. 7C, the user again selects the region selection button 941 for setting a desired region or a desired graphic element as a haptic region. In FIG. 7F, the user selects the rewind button as the second local haptic region 1050 and then selects the setting button 942 in order to bring up the haptic type setting screen 930b.

In FIG. 7G, the haptic type setting screen 930b is displayed in response to the user selection of the setting button 942 in FIG. 7F. An image 1050a of the second local haptic region 1050 (i.e., the rewind button), together with the guide phrase 934 “SET TYPE OF HAPTIC PATTERN”, is displayed on the haptic type setting screen 930b. Like FIG. 7D, selectable first through fifth haptic types/patterns 971, 972, 973, 974, and 975 are again displayed on the haptic type setting screen 930b.

In FIG. 7G, the user selects first haptic type 971 (“DENTED FEELING”) for the second local haptic region 1050 (i.e. rewind button) with the vibration option 971a (“VIBE”), and then presses setting button 942.

In FIG. 7H, the local haptic environment setting confirm screen 930c is displayed to the user. The local haptic environment setting confirm screen 930c in FIG. 7H displays the previously user-set local haptic effect details under “Local Haptic #1” 1010 and the second local haptic effect to be presently set/confirmed under “Local Haptic #2” 1012. Under “Local Haptic #2” 1012 appears information 1022 indicating that the first haptic type 971 (“DENTED FEELING”) with vibration is assigned by the user to the second local haptic region 1050 (i.e., the rewind button).

Again the user selects button 1030 for setting the next local haptic region, resulting in the local haptic region setting screen 930a being displayed in FIG. 7I.

In FIG. 7I, the user selects the region selection button 941 in order to set the next desired region, i.e., the third local haptic region. Next, the user selects the fast-forward button as the third local haptic region 1055. Thereafter, the user selects the setting button 942 in order to bring up the local haptic type setting screen 930b.

FIG. 7J, the haptic type setting screen 930b is displayed. An image 1055a of the selected third local haptic region 1055 (i.e., the fast forward button), together with the selectable first through fifth haptic types/patterns 971, 972, 973, 974, and 975, are displayed on the haptic type setting screen 930b. In FIG. 7J, the user selects the third haptic type 973 (“GENTLE WAVE FEELING”) for the selected third local haptic region 1055 and then selects setting button 942.

In FIG. 7K, the local haptic environment setting confirm screen 930c is displayed to the user. On the local haptic environment setting confirm screen 930c, the previously user-set local haptic effect details are arranged and displayed as “Local Haptic #1” and “Local Haptic #2”. The third local haptic effect “Local Haptic #3” 1014 presents information 1024 indicating the third haptic type 973 (“GENTLE WAVE FEELING”) is being assigned by the user to the third selected local haptic region (i.e., the fast-forward button).

Instead of continuing the haptic setting process, the user selects the complete button 943 for ending the local haptic environment setting operation, and the music/video application screen 910 returns, as illustrated in FIG. 7L. That is, upon user's selection of the complete button 943, the processor returns to the mode before the setting operation (in the current example, the music/video application) from the local haptic environment setting mode.

When the music/video application is executed, the music/video application automatically enters a local haptic feedback providing mode with reference to the local haptic environment settings.

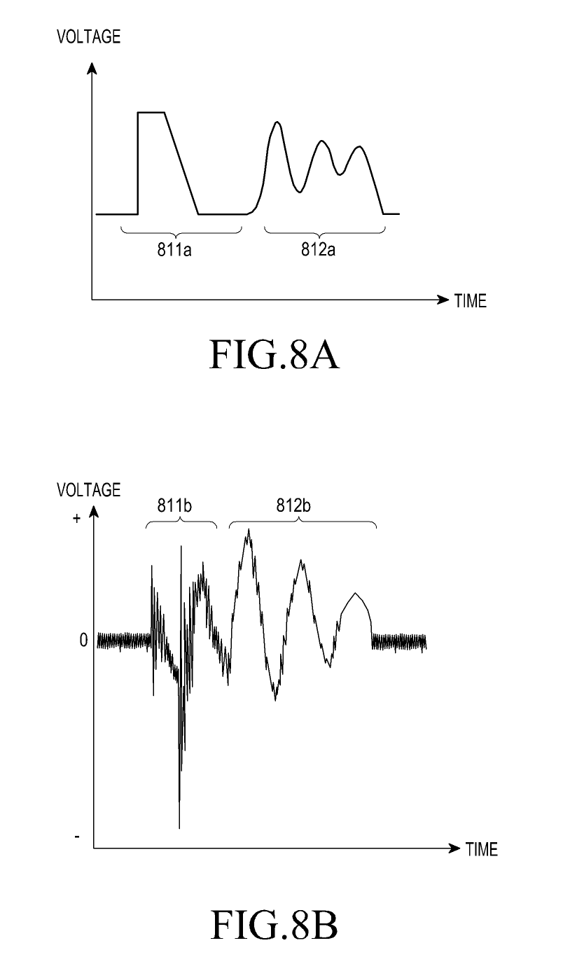

FIGS. 8A through 15 are diagrams relating to various vibration patterns. In each drawing, the horizontal axis indicates time and the vertical axis indicates voltage. Each vibration waveform indicates vibration strength based on ‘0’ as a voltage with respect to vibration direction (+ or −) over time. The + vibration direction indicates a front direction of the electronic device 101 and the − vibration direction indicates a rear direction of the electronic device 101. In other embodiments, the relative direction of vibration may be different and/or multiple/selectable in direction.

FIG. 8A illustrates a control signal output to a haptic module to generate vibrations corresponding to the first haptic type 971 (“DENTED FEELING”). FIG. 8B shows the resulting vibration waveform. The control signal is divided into a first signal part 811a and a second signal part 812a. The first signal part 811a is applied when a user input means contacts or approaches a local haptic region, and the second signal part 812a is applied when the user input means is spaced apart from or is directed away from the local haptic region.

As shown in FIG. 8A, in the first signal part 811a, as vibration strength in the − direction increases, a resulting vibration gives a dented feeling to the user. In the second signal part 812a, a sine waveform is provided and the amplitude thereof gradually decreases. In FIG. 8B, the vibration waveform includes a first waveform part 811b corresponding to the first signal part 811a and a second waveform part 812b corresponding to the second signal part 812a. It can be seen that in the first waveform part 1511b, vibration strength in the − direction is very high.

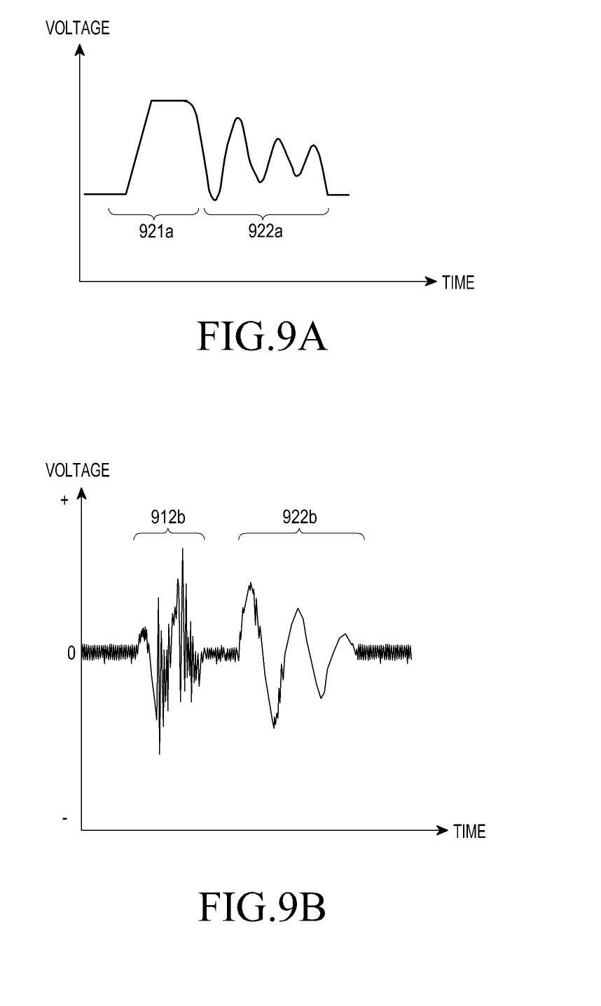

FIG. 9A shows a control signal output to a haptic module to generate vibrations corresponding to the second haptic type 972 (“PROTRUDING FEELING”). FIG. 9B shows the resulting vibration waveform. The control signal is divided into a first signal part 921a and a second signal part 922a. The first signal part 921a is applied when a user input means contacts or approaches a local haptic region, and the second signal part 922a is applied when the user input means is spaced apart from or is directed away from the local haptic region.

In FIG. 9A, during the first signal part 921a, vibration strength in the + direction increases, and a resulting vibration gives a protruding feeling to the user. In the second signal part 922a, a sine waveform is provided and the amplitude thereof gradually decreases. In FIG. 9B, the drive voltage waveform of the haptic module includes a first waveform part 921b corresponding to the first signal part 921a and a second waveform part 922b corresponding to the second signal part 922a.

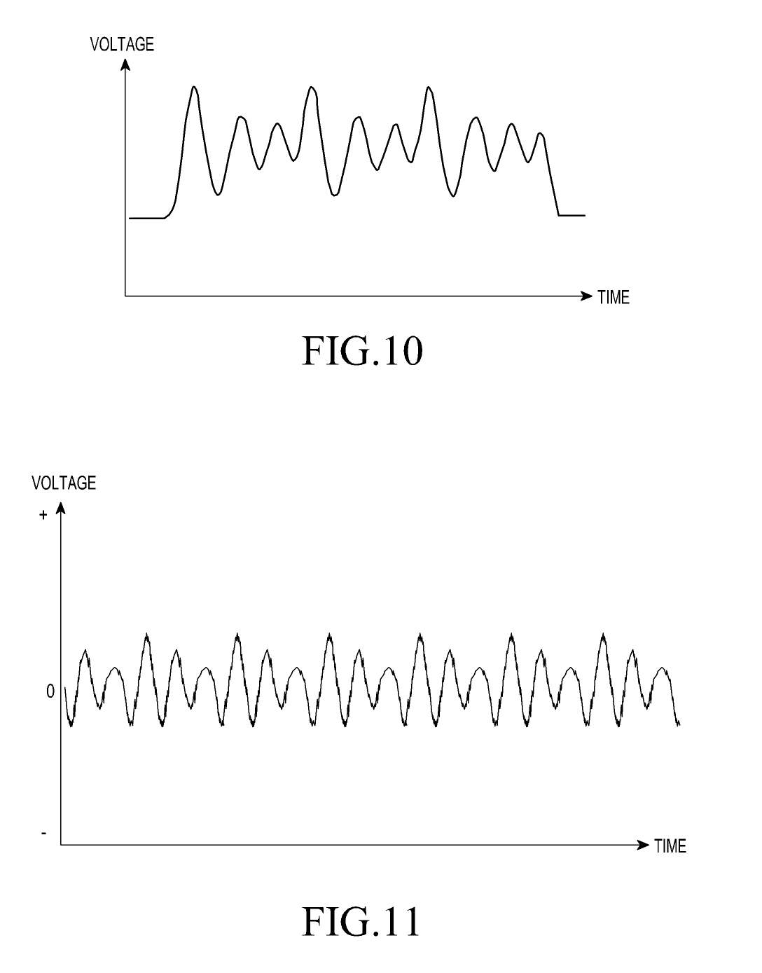

FIG. 10 illustrates a control signal output to generate vibrations corresponding to the third haptic type 973 (“GENTLE WAVE FEELING”). FIG. 11 shows the resulting vibration waveform. The control signal has a sine waveform whose amplitude periodically increases and then decreases. A resulting vibration corresponding to the sine waveform whose amplitude periodically increases and then decreases gives a gentle wave feeling to the user. The vibration waveform is similar to the waveform of the control signal.

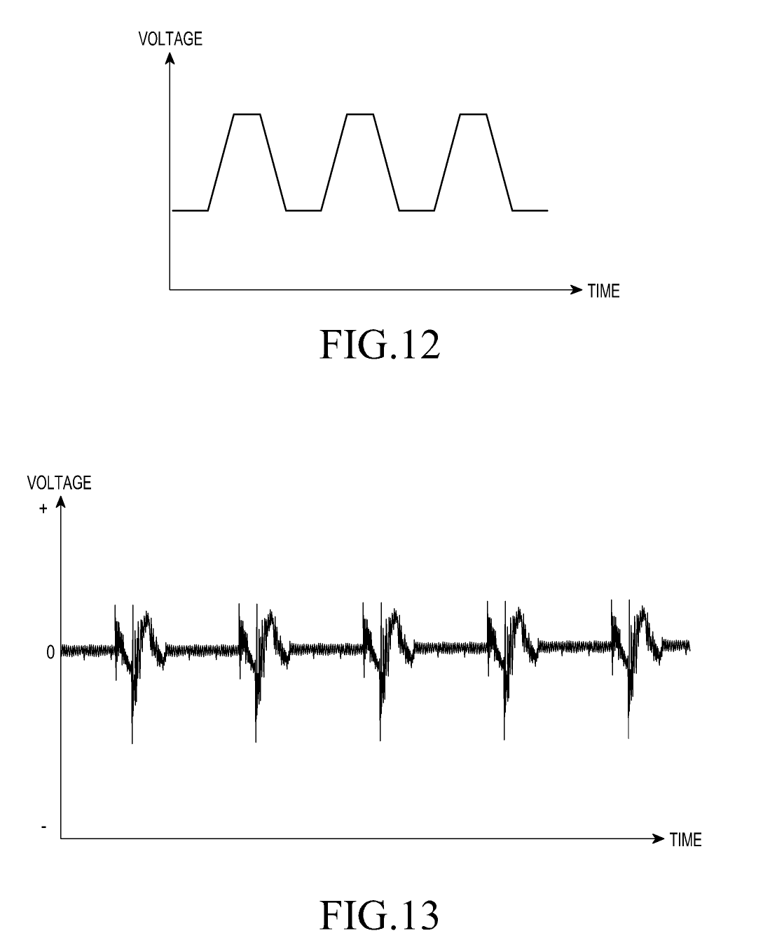

FIG. 12 illustrates a control signal output to generate vibrations corresponding to the fourth haptic type 974 (“SAWING FEELING”). FIG. 13 shows the resulting vibration waveform. The control signal has a periodic trapezoid, triangle, or saw-toothed waveform. A resulting vibration corresponding to the trapezoid, triangle, or saw-toothed waveform gives a sawing feeling to the user. The waveform is similar to the first waveform part 811b illustrated in FIG. 8B.

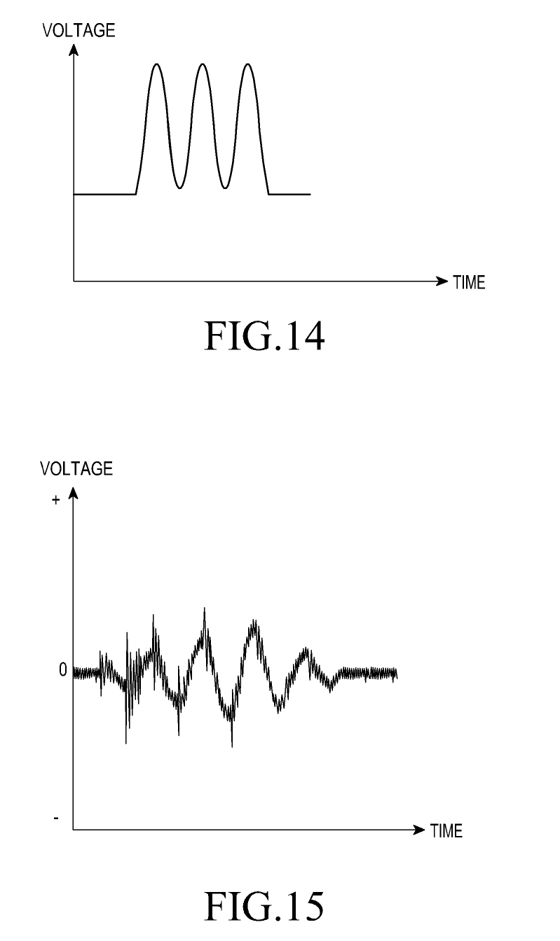

FIG. 14 illustrates a control signal output to generate vibrations corresponding to the fifth haptic type 975 (“SHORT VIBRATION”). FIG. 15 illustrates the resulting vibration waveform. The control signal has a periodic sine waveform. The resulting vibration corresponding to the sine waveform gives a short vibration feeling to the user. The drive voltage waveform is similar to the waveform of the control signal.

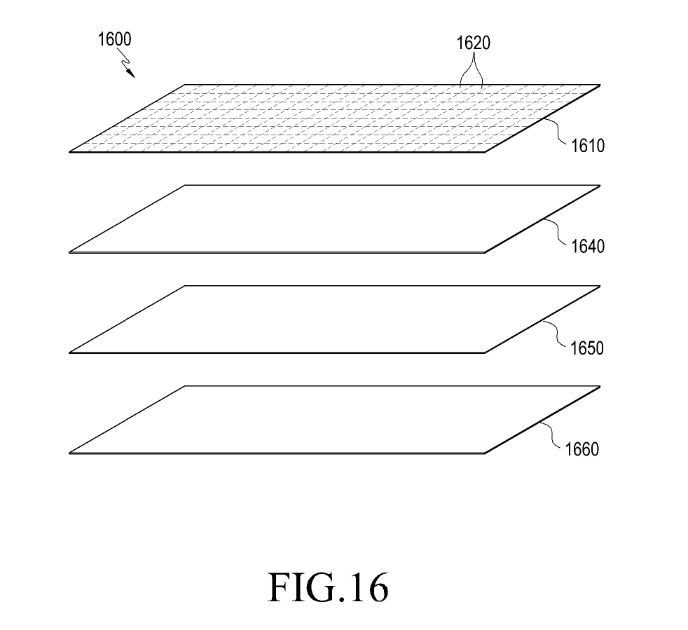

FIG. 16 is a diagram illustrating a display according to various embodiments of the present disclosure.

In FIG. 16, display 1600 (which could be an implementation of, e.g., display 160 or 260) includes a haptic module 1610 (which could be one possible implementation of, e.g., the second haptic module 184 in FIG. 1) for providing a 3D tactile sense, a first touch panel 1640 for sensing a finger input, a display panel 1650 for screen display, and a second touch panel 1660 for sensing a pen input are sequentially disposed by closely contacting one another and/or by being partially spaced apart from one another. The first touch panel 1640 may be disposed under the display panel 1650 in other embodiments.

The haptic module 1610 includes a plurality of haptic elements 1620 disposed in an N×M matrix structure, and each haptic element of the plurality of haptic elements 1620 may have the same structure. Each haptic element 1620 may correspond to at least one pixel of the display panel 1650, i.e., the plurality of haptic elements 1620 may be disposed such that each haptic element 1620 corresponds to a predetermined number of pixels of the display panel 1650.

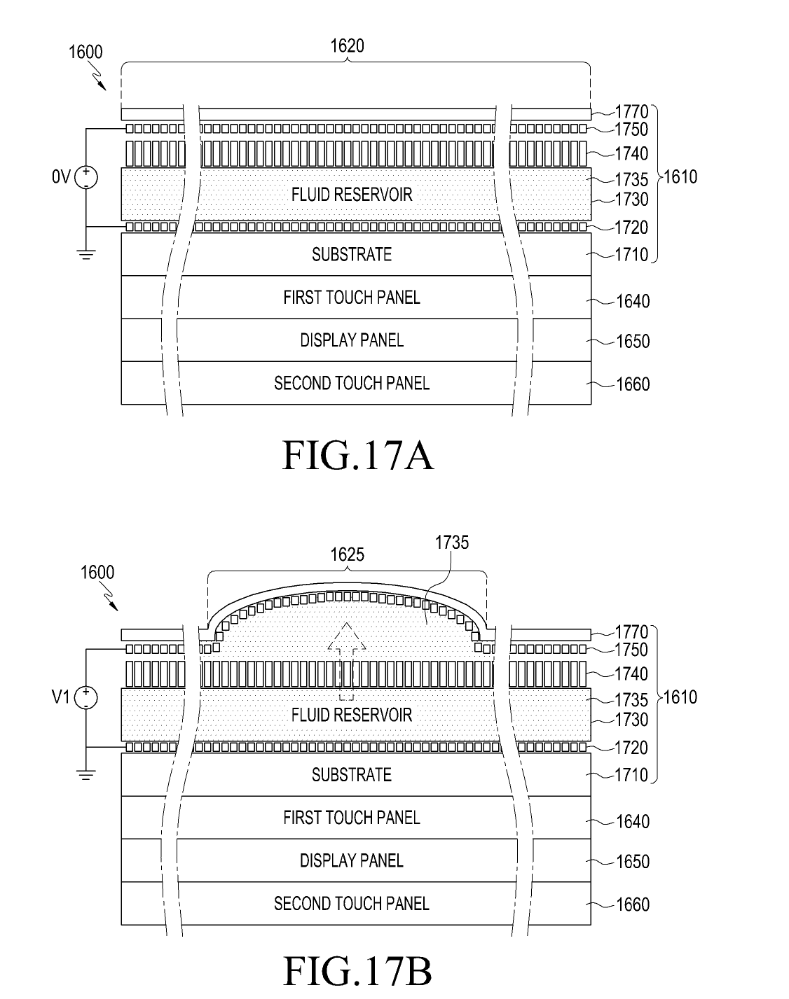

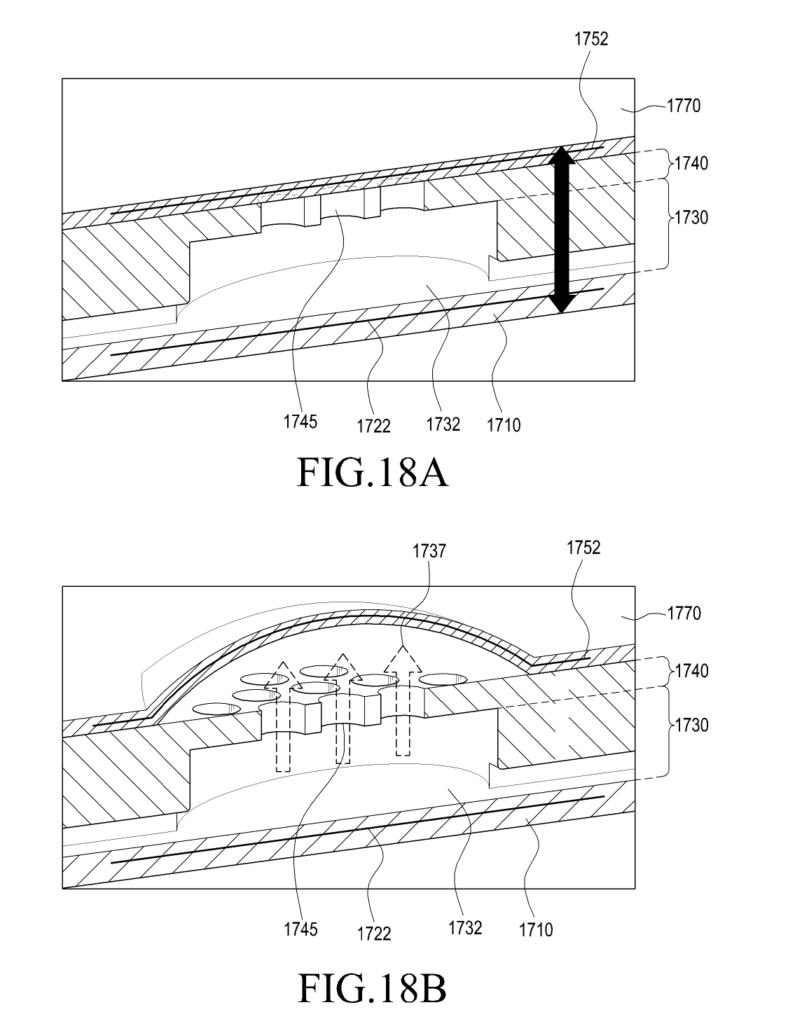

FIGS. 17A through 18B are diagrams illustrating a display using electro-osmosis, according to an embodiment of the present invention.

In FIG. 17A, the haptic module 1610 includes, from bottom to top, a substrate 1710, a first electrode layer 1720, a fluid reservoir 1730 containing a fluid 1735, a membrane 1740, a second electrode layer 1750, and a tactile layer 1770 sequentially disposed by either closely contacting with one another and/or being at least partially spaced apart from one another.

The substrate 1710 may be formed of a transparent insulating material, for example, a plastic or glass material. The plastic may be, for example, one of polyacrylate, polyethylene terephthalate, polyethylene naphthalate, polycarbonate, polyarylate, polyetherimide, polyethersulfone, and polyimide. A bottom surface of the substrate 1710 is attached to a top surface of the first touch panel 1640 using an adhesive member.

The first electrode layer 1720 is disposed on a top surface of (or is buried in an upper portion of) the substrate 1710 and is connected with ground. The first electrode layer 1720 includes a plurality of first electrodes corresponding to the plurality of haptic elements 1620, and each of the plurality of first electrodes may operate independently. An insulating layer may be disposed on a top surface of the first electrode layer 1720. The first electrode layer 1720 may be formed of a transparent conductive material, for example, at least one of indium tin oxide (ITO), fluorine tin oxide (FTO), antimony doped tin oxide (ATO), aluminum, polyacetylene, and polythiophene, and/or any combination thereof. As another example, the insulating layer may be formed as an Ajinomoto build-up film (ABF).

The fluid reservoir 1730 is disposed on the top surface of the first electrode layer 1720. The fluid reservoir 1730 stores fluid 1735, which may be an electrolyte solution, oil, water, alcohol, liquid paraffin, and/or the like. In some embodiments of the present disclosure, the fluid 1735 is air and the fluid reservoir 1730 may be a space that can contain air. The fluid in the fluid reservoir 1730 may be moved due to electro-osmosis. The fluid reservoir 1730 may be formed of a material such as silicon, fused silica, glass, or the like.

Membrane 1740 is disposed between the fluid reservoir 1730 and tactile layer 1770, and may include a plurality of channels (or holes) serving as a path through which the fluid in the fluid reservoir 1730 moves to the tactile layer 1770. The membrane 1740 may be formed integrally with the fluid reservoir 1730. The membrane 1740 may be formed of a material such as silicon, fused silica, glass, or the like.

The tactile layer 1770 is disposed on a top surface of haptic module 1610, above membrane 1740. The tactile layer 1770 may be formed of a transparent elastomeric material, such as polyurethane, silicon, or the like.

The second electrode layer 1750 is disposed on a bottom surface of (or buried in a lower portion of) the tactile layer 1770, above membrane 1740. The second electrode layer 1750 includes a plurality of second electrodes corresponding to the plurality of haptic elements 1620, and each of the plurality of second electrodes may operate independently. An insulating layer may be disposed on a bottom surface of the second electrode layer 1750. The second electrode layer 1750 may be formed of a transparent conductive material. The insulating layer may be formed as an ABF.

Electro-osmosis refers to the phenomenon in which the application of an electric field to a fluid contacting a charged solid surface causes the bulk movement of the fluid. Inner surfaces of the fluid reservoir 1730 and the membrane 1740 have negative charges due to contact with the fluid, and counter-ions in the fluid move to the negative charges, such that an electric double layer (EDL) is formed in an area adjacent to the inner surfaces. Upon application of the electric field to the fluid where the EDL is formed, movement of the fluid occurs. FIG. 17B illustrates an example of electro-osmosis.

In FIG. 17B, the electronic device selectively operates some haptic elements of a region 1625 of the haptic module 1610, which correspond to a local haptic region. A first voltage is also applied between the first electrode layer 1720 and the second electrode layer 1750 corresponding to the haptic element region 1625 within the haptic element grid 1620. Upon application of the first voltage, an electric field is generated between the first electrode and the second electrode, and fluid 1735 in the fluid reservoir 1730 moves toward the tactile layer 1770 due to the electric field, and a portion of the tactile layer 1770 corresponding to haptic element region 1625 protrudes in a convex manner.

If the first voltage is released, the fluid 1735 introduced to the tactile layer 1770 returns to the fluid reservoir 1730. In other embodiments of the present disclosure, a second voltage that is opposite to the first voltage is applied between the first electrode and the second electrode included in the haptic element region 1625 to return fluid 1735 to the fluid reservoir 1730. When the fluid returns, the portion of the tactile layer 1770 included in the haptic element region 1625 is restored to a flat state.

FIGS. 18A and 18B are magnified views of the layers of haptic module 1610 in FIGS. 17A and 17B, respectively, according to an embodiment of the present invention.

In FIG. 18A, the membrane 1740 includes a plurality of channels 1745 (or holes) serving as a path through which the fluid from space 1732 in the fluid reservoir 1730 moves to the tactile layer 1770. For example, the haptic module 1610 may globally have a thickness of 1 mm or less, and each of the plurality of channels 1745 may have a diameter (or width) of about 200 μm.

In FIGS. 18A and 18B, the first electrode layer 1722 is buried in the substrate 1710, and the second electrode layer 1752 is buried in the tactile layer 1770.

In FIG. 18B, the first voltage is applied between the first electrode 1722 and the second electrode 1752, generating the electric field which causes the fluid 1735 in space 1732 of the fluid reservoir (or storage) 1730 to move toward the tactile layer 1770 as indicated by arrows 1737, such that a portion of the tactile layer 1770 corresponding to the haptic element region 1625 protrudes in a convex manner due to the moving fluid.

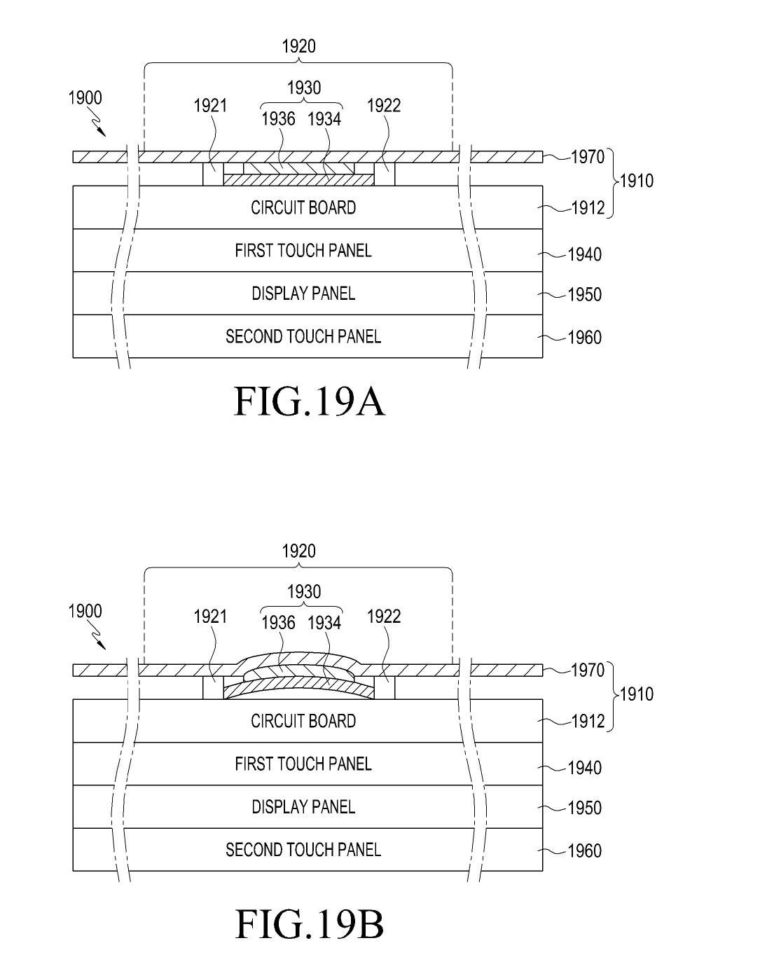

FIGS. 19A through 21B are diagrams illustrating displays using piezoelectric elements, according to various embodiments of the present disclosure.

In FIG. 19A, display 1900 includes, from top to bottom, a haptic module 1910, a first touch panel 1940 for sensing a finger input, a display panel 1950 for screen display, and a second touch panel 1960 for sensing a pen input are sequentially disposed by closely contacting with one another and/or by being at least partially spaced apart from one another. In other embodiments, the first touch panel 1940 may be disposed under the display panel 1950, and one of the first touch panel 1940 and the second touch panel 1960 may be omitted or they may be replaced with a single touch panel capable of detecting both a finger input and a pen input.

The haptic module 1910 includes a plurality of haptic elements 1920 disposed in an N×M matrix structure, and each of the plurality of haptic elements 1920 may have the same structure. Each haptic element in the plurality 1920 may correspond to at least one pixel of the display panel 1950, i.e., the plurality of haptic elements 1920 may be disposed such that each haptic element in plurality 1920 corresponds to a predetermined number of pixels of the display panel 1950. The haptic module 1910 includes, from bottom to top, a circuit board 1912, a plurality of haptic elements 1920, and a tactile layer 1970 are sequentially disposed by closely contacting with one another and/or by being at least partially spaced apart from one another.

The circuit board 1912 may include a substrate formed of a transparent insulating material and a circuit layer formed on the substrate and electrically connected to the plurality of haptic elements 1920. The electronic device selectively operates some haptic elements corresponding to a local haptic region to which voltage is applied.

The plurality of haptic elements 1920 includes a transparent first support 1921, a transparent second support 1922, and a transparent piezoelectric element (or piezoelectric diaphragm) 1930. The first support 1921 is fixed onto the top surface of the circuit board 1912 and supports (or fixes) one end of the piezoelectric element 1930 and the second support 1922 is fixed onto the top surface of the circuit board 1912 and supports (or fixes) the other end of the piezoelectric element 1930.

The piezoelectric element 1930, which may be transformed by an application of voltage, includes a transparent elastic plate 1934 and a transparent piezoelectric ceramic 1936. The elastic plate 1934 may be formed of a transparent metallic material and may be bent by the extension or shrinkage of the piezoelectric ceramic 1936, which may extend or shrink by application of a voltage.

The tactile layer 1970 is disposed on the plurality of haptic elements 1920. The tactile layer 1970 may be formed of a transparent elastomeric material, and at least a part of the piezoelectric ceramic 1936 may be adhered to the tactile layer 1970 by using an adhesive member.

In FIG. 19B, piezoelectric element 1930 of the plurality of haptic elements 1920 corresponds to a local haptic region being selectively operated. More specifically, a positive first voltage is applied to the piezoelectric ceramic 1936 of piezoelectric element 1930 and, upon application of the first voltage, the piezoelectric ceramic 1936 extends, causing the elastic plate 1934 to be bent in a convex manner. As the elastic plate 1934 is transformed in this way, a portion of the tactile layer 1970 above the selectively operated haptic region protrudes in a convex manner. The elastic plate 1934 of the piezoelectric element 1930 may be connected with ground. Upon release of the first voltage, the portion of the tactile layer 1970 returns to the flat state.

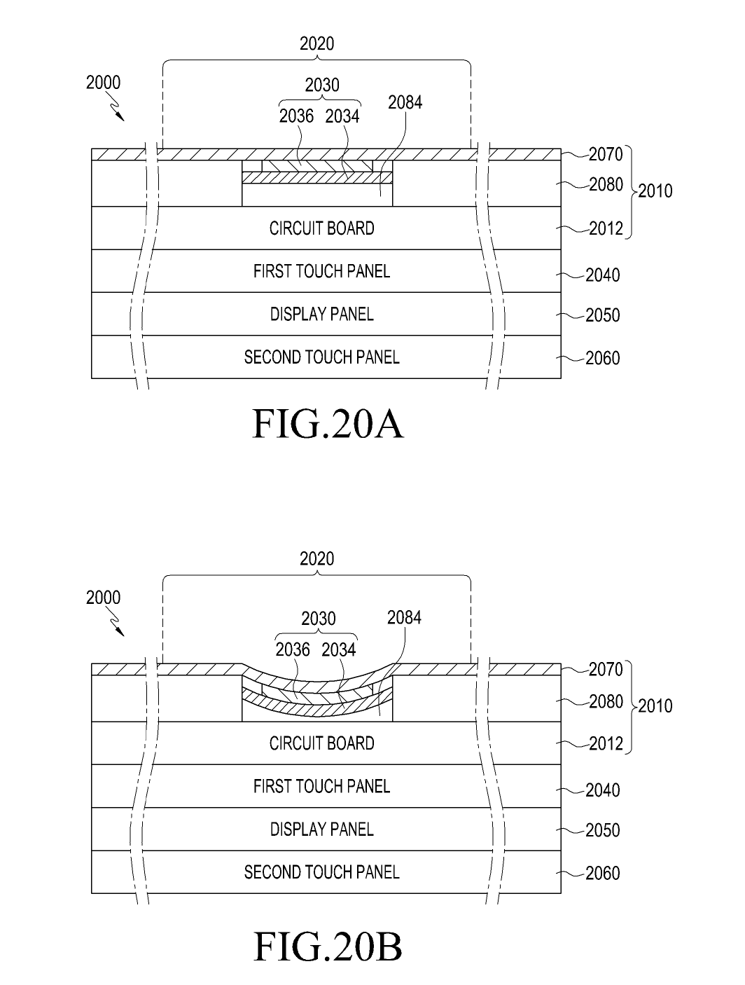

FIGS. 20A and 20B are diagrams illustrating a display using piezoelectric elements, according to an embodiment of the present disclosure.

In FIG. 20A, display 2000 includes, from top to bottom, a haptic module 2010 for providing a 3D tactile sense, a first touch panel 2040 for sensing a finger input, a display panel 2050 for screen display, and a second touch panel 2060 for sensing a pen input are sequentially disposed by closely contact with one another and/or by being partially spaced apart from one another. In other embodiments, the first touch panel 2040 may be disposed under the display panel 2050, and one of the first touch panel 2040 and the second touch panel 2060 may be omitted or they may be replaced with one touch panel capable of detecting a finger input and a pen input.

The haptic module 2010 includes a plurality of haptic elements 2020 disposed in an N×M matrix structure, and each of the plurality of haptic elements 2020 may have the same structure and may correspond to at least one pixel of the display panel 2050. The haptic module 2010 includes, from bottom to top, a circuit board 2012, a support substrate 2080, and a tactile layer 2070 sequentially disposed by closely contacting with one another and/or by being at least partially spaced apart from one another. The tactile layer 2070 may be formed of a transparent elastomeric material and disposed on a top surface of the support substrate 2080.

The support substrate 2080 is disposed on a top surface of the circuit board 2012 and includes a plurality of holes 2084 for receiving (and/or supporting) the plurality of haptic elements 2020.

Each haptic element includes a transparent piezoelectric element 2030 (or piezoelectric diaphragm), which can be transformed by the application of a voltage. The piezoelectric element 2030 includes an elastic plate 2034 and piezoelectric ceramic 2036. The piezoelectric ceramic 2036 extends or shrinks when voltage is applied, and the elastic plate 2034 may be bent in a convex or concave manner by the extension/shrinkage of the piezoelectric ceramic 2036.

The circuit board 2012 may include a substrate formed of a transparent insulating material and a circuit layer formed on the substrate and electrically connected to the plurality of haptic elements 2020. A local haptic region may be selectively operated by applying a voltage to one or more haptic elements from among the plurality of haptic elements 2020 through the circuit layer, which may be formed of a transparent conductive material. A bottom surface of the circuit board 2012 may be adhered to a top surface of the first touch panel 2040.

Referring to FIG. 20B, the processor selectively operates some piezoelectric elements of the haptic module 2010, which correspond to a local haptic region. More specifically, the processor may apply a positive voltage or negative voltage to either the elastic plate 2034 or the piezoelectric ceramic 2036 of piezoelectric element 2030 included in the plurality of haptic elements 2020.

The elastic plate 2034 of the piezoelectric element 2030 is connected with ground, and if either a negative voltage is applied to the piezoelectric ceramic 2036 or a positive voltage is applied to the elastic plate 2034 such that the potential of the elastic plate 2034 is higher than that of the piezoelectric ceramic 2036, the piezoelectric ceramic 2036 shrinks, causing the elastic plate 2034 to be bent in a concave manner. As the elastic plate 2034 is transformed, a portion of the tactile layer 2070 above the piezoelectric element 2030 is dented in a concave manner.

On the other hand, if a positive voltage is applied to the piezoelectric ceramic 2036 or a negative voltage to the electric plate 2034 such that the potential of the piezoelectric ceramic 2036 is higher than that of the elastic plate 2034, the piezoelectric ceramic 2036 extends, causing the elastic plate 2034 to be bent in a convex manner. As the elastic plate 2034 is transformed, a portion of the tactile layer 2070 above the piezoelectric element 2030 protrudes in a convex manner.

Upon release of the voltage, the portion of the tactile layer 2070 above a selected local haptic region included within the plurality of haptic elements 2020 is restored to the flat state.

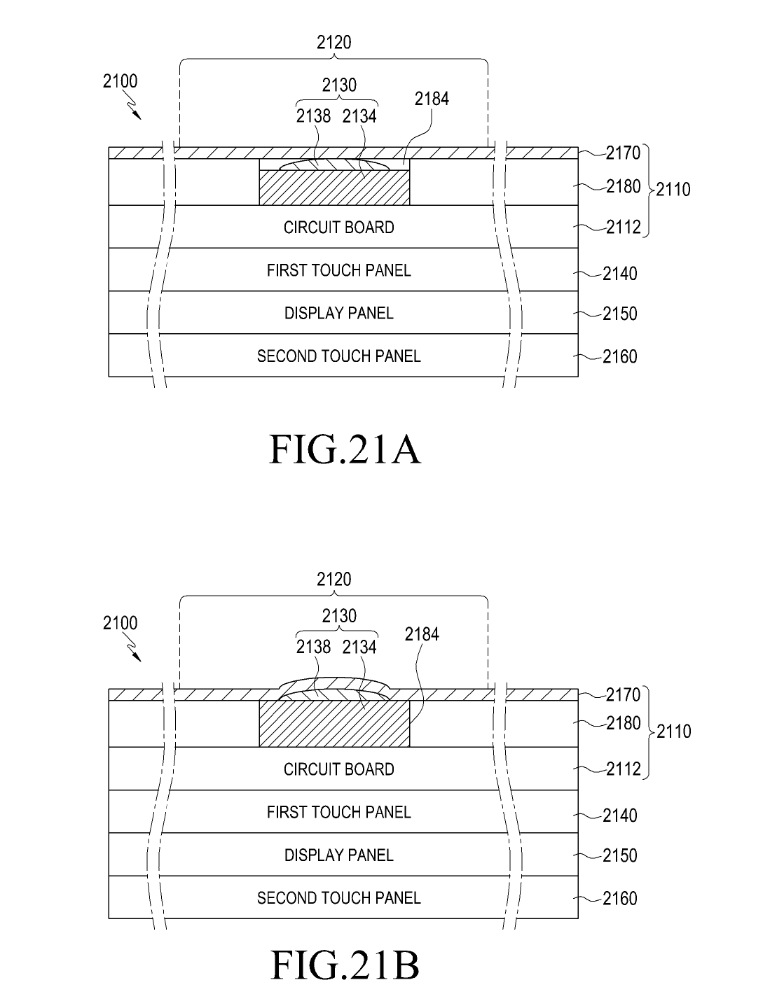

FIGS. 21A and 21B are diagrams illustrating a display using piezoelectric elements, according to an embodiment of the present disclosure.

In FIG. 21A, display 2100 includes, from top to bottom, a haptic module 2110 for providing a 3D tactile sense, a first touch panel 2140 for sensing a finger input, a display panel 2150 for screen display, and a second touch panel 2160 for sensing a pen input sequentially disposed by closely contacting one another and/or by being partially spaced apart from one another.

The haptic module 2110 includes a plurality of haptic elements 2120 disposed in an N×M matrix structure, and each of the plurality of haptic elements 2120 may have the same structure and may correspond to at least one pixel of the display panel 2150. The haptic module 2110 includes, from bottom to top, a circuit board 2112, a support substrate 2180, and a tactile layer 2170 sequentially disposed by closely contacting with one another and/or by being at least partially spaced apart from one another. The tactile layer 2170 may be disposed on the top surface of the support substrate 2180 and may be formed of a transparent elastomeric material.

The support substrate 2180 is disposed on the top surface of the circuit board 2112 and includes a plurality of holes 2184 for receiving (and/or supporting) the plurality of haptic elements 2120. Each haptic element 2120 includes a transparent piezoelectric element or a piezoelectric actuator 2130. The piezoelectric element 2130 may be transformed by the application of voltage and includes a piezoelectric ceramic 2134 and a cap 2138.

The cap 2138 is configured for transforming the tactile layer 2170 into a desired form, and the cap 2138 may form a portion of the piezoelectric ceramic 2134. The cap 2138 may take a form such as, for example, a semi-sphere, a truncated cone, a cylinder, or the like. The piezoelectric ceramic 2134 may extend or shrink by application of a voltage.

In FIG. 21B, the piezoelectric element 2130 is selectively operated as a local haptic region, by applying a voltage to the piezoelectric element 2130. Upon application of the voltage, the piezoelectric element 2130 extends along a thickness direction of the display 2100 (or in a direction normal to the top surface of the circuit board 2112). As the piezoelectric element 2130 extends (or is transformed), a portion of the tactile layer 2170 included in the local haptic region protrudes in a convex manner. Upon release of the voltage applied to the piezoelectric element 2130, the portion of the tactile layer 2170 included in the local haptic region is restored to the flat state.

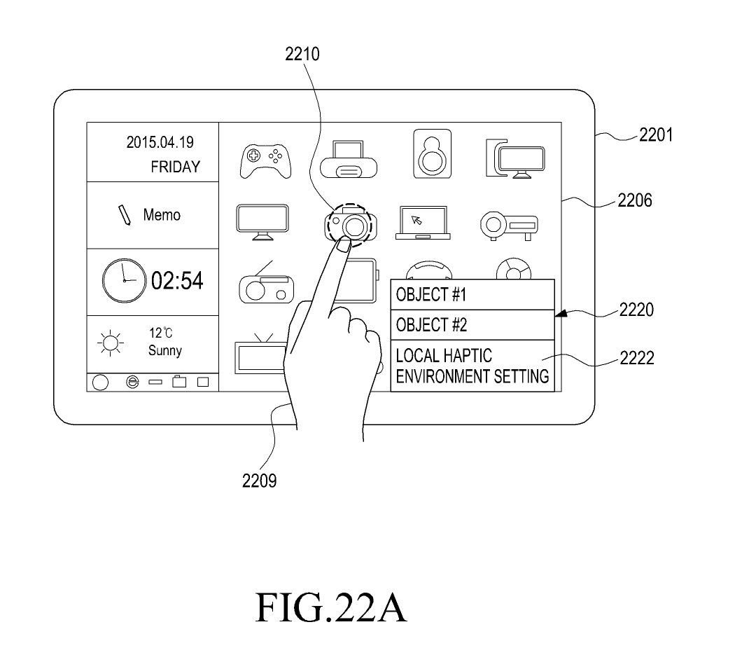

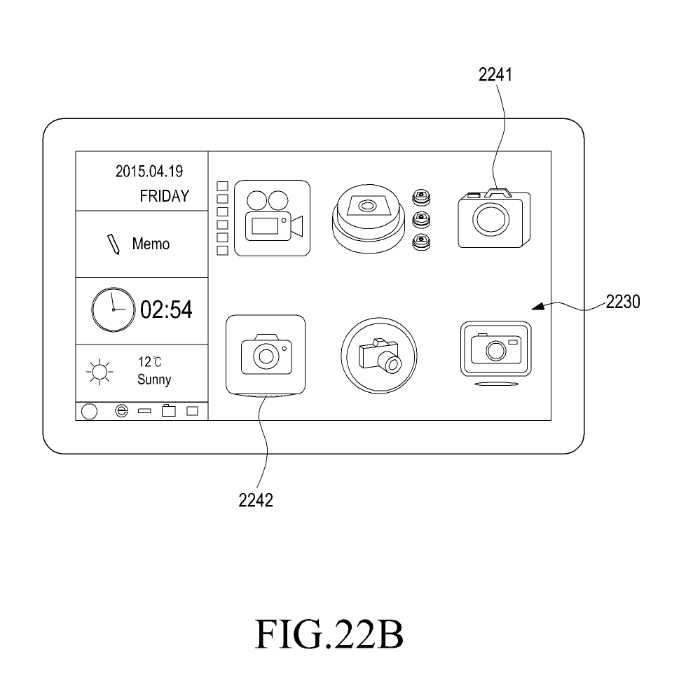

FIGS. 22A and 22B are diagrams illustrating a method for setting a local haptic environment according to various embodiments of the present disclosure.

In FIG. 22A, electronic device 2201 detects an input from a finger on the user's hand 2209 on icon 2210 among a plurality of icons displayed on a display 2206. In response, menu 2220 is displayed including local haptic environment setting button 2222. Upon the user selecting the local haptic environment button 2222, the local haptic environment setting screen 2230 is displayed as illustrated in FIG. 22B. The local haptic environment setting screen 2230 includes 3D transformation types, identified by, for example, icons 2241 and 2242, that can be applied to the selected icon 2210. Examples of possible 3D transformations include the protruding feeling type indicated by icon 2241, and the dented feeling type indicated by icon 2242, and a type combining the protruding feeling and dented feeling types.

The processor detects a user input for selecting an icon corresponding to one of the 3D transformation types and sets the previously-selected camera icon 2210 to the selected 3D transformation type.

For example, if a 3D transformation option is set in a local haptic region and a user input position is included in the local haptic region, then the processor operates such that haptic elements (e.g., the haptic elements 1620, 1920, 2020, and 2120) corresponding to the local haptic region are transformed in a convex manner and/or in a concave manner.

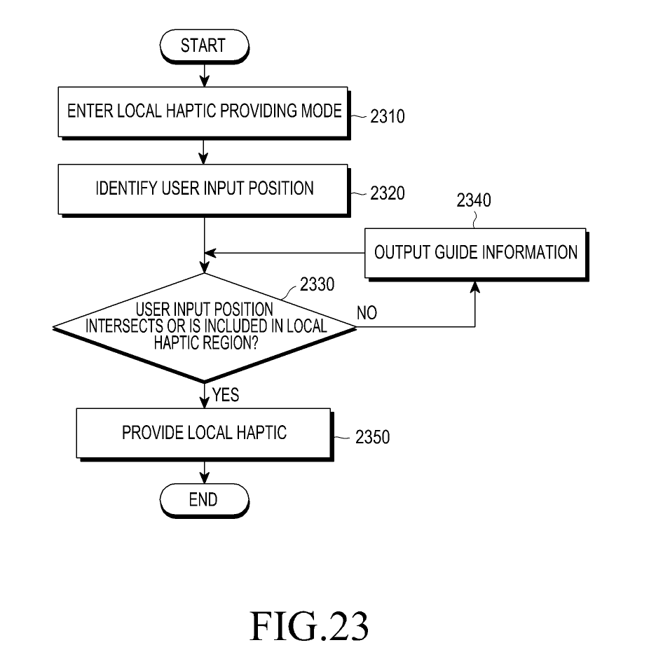

FIG. 23 is a flowchart illustrating a method for providing a local haptic effect according to various embodiments of the present disclosure.

In step 2310, the electronic device enters the local haptic providing mode. In order to enter local haptic providing mode, the user may execute an application in which local haptic effects are set in advance, or the user may input a command instructing entry into the local haptic providing mode after executing an application. Alternatively, if the user executes an application, the application may automatically enter the local haptic providing mode with reference to local haptic environment settings.

To enter the local haptic providing mode, the user may a) press a button, b) select an icon or a function item through the display, c) generate an input of a preset pattern (for example, a double-tap, a motion of putting two fingers which are touching the screen together or apart, or a motion of drawing a circle with a finger which is touching the screen) on the display, d) input a voice command through a microphone, e) generate a gesture or a motion input through a camera module, or f) wirelessly input a particular command through a communication device (such as, e.g., the communication module 170 or the communication module 220).

In step 2310, an application screen having one or more local haptic regions is displayed. In step 2320, the user input position is identified with respect to the display. For example, a processor in the electronic device may receive a signal including information about the user input position from the display and identify the user input position from the received signal.

In step 2330, whether the user input position intersects or is included in a local haptic region is detected or determined. Step 2350 is performed if the user input position intersects a local haptic region; otherwise, step 2340 is performed if the user input position does not intersect a local haptic region. That is, the electronic device detects or determines whether the coordinates of the user input position are included in a coordinate region which defines a local haptic region. For example, if a local haptic region has a quadrilateral shape, the device may determine whether the coordinates of the user input position are among the coordinates within the four corners of the local haptic region.

In step 2340, the device guides the user to a local haptic region. For example, a processor of the device may recognize an input position of the user input means (that is, a user input position) and output guide information for allowing the user input means to quickly move to the local haptic region. The guide information may include information indicating a position or a direction of the local haptic region, a distance between the input position and the local haptic region, and/or the like. The processor may output the guide information in the form of vibration or sound. The step of guiding the local haptic region is an optional step and thus may be omitted or added. As such, if step 2340 is omitted, the processor may stand by until the user input position intersects a local haptic region.

In steps 2320 through 2340, the touch may be input by at least one of a finger including a thumb and/or an input unit. The touch may be input by contacting the display and/or hovering over the display. The local haptic region may be any one or more of a key, a button, a text, an image, a shortcut icon, an icon, and a menu displayed on the application screen.

In step 2350, the local haptic effect is provided to the user. For example, a processor of the electronic device may control an input unit (such as a stylus) and/or at least one haptic module in the electronic device to generate a haptic feedback/effect (e.g., vibration, transformation of a local haptic region, or the like) corresponding to a haptic type which is set in the local haptic region if the user input position intersects (or is included in) the local haptic region. The haptic effect may have been set by the user. The processor may provide sound, corresponding to the haptic effect, together with the haptic effect.

The function item corresponding to the selected local haptic region may be selected or executed, together with providing of the haptic effect, or may be selected or executed by an additional touch of the user input means.

According to various embodiments of the present disclosure, the processor provides the haptic effect if the user input means immediately touches the local haptic region. If the user input means does not immediately touch the local haptic region, the processor does not provide the haptic effect and determines a swipe, flick, or drag path of the user input means and continuously determines whether to provide the haptic effect while continuously storing the user input position. That is, the processor continuously tracks the user input position during a swipe of the user input means and continuously determines whether the user input position intersects the local haptic region. In other words, the processor performs an operation of detecting continuous movement of a touch and an operation of detecting an entrance of the continuous movement into the local haptic region.

According to various embodiments of the present disclosure, the type of haptic effect corresponding to a touch and the type of haptic effect corresponding to a moving touch which enters the local haptic region may be different from each other. That is, the type of haptic effect corresponding to an entering touch made by a swipe in the local haptic region and the type of haptic effect corresponding to a touch in the local haptic region for execution of the function item may be different from each other. For example, the haptic effect of the protruding feeling may be provided to the moving/entering touch in the local haptic region, and the short vibration may be provided for the additional touch for execution of the function item.

Each of a plurality of local haptic regions may be provided with its own different haptic effect.

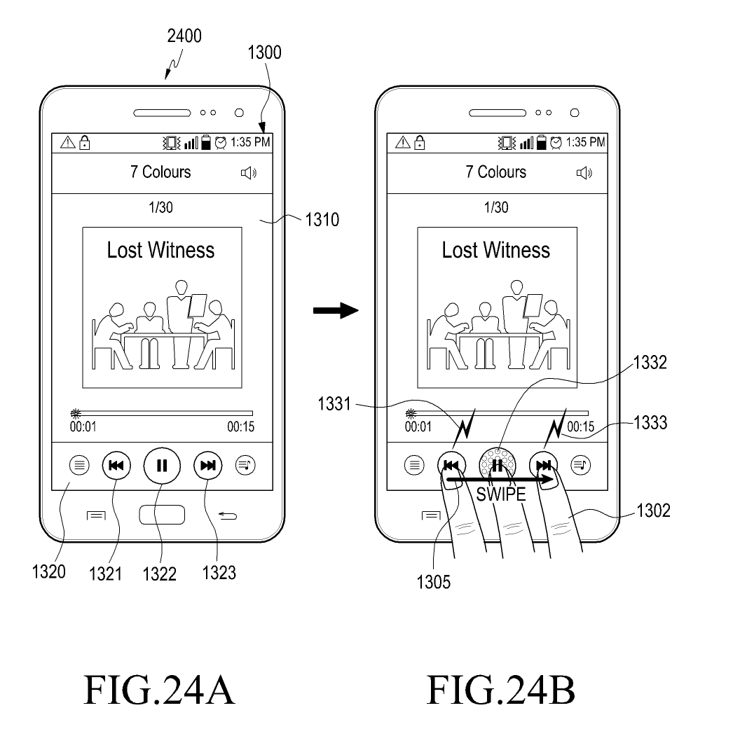

FIGS. 24A and 24B illustrate a method for providing local haptic effects according to various embodiments of the present disclosure.

In FIG. 24A, the electronic device 2400 executes a music/video application having music/video application screen 1300. A menu 1320 and a playback screen 1310 are displayed on the music/video application screen 1300. The menu 1320 includes a re-wind button corresponding to a first local haptic region 1321, a pause/play button corresponding to a second local haptic region 1322, and a fast-forward button corresponding to a third local haptic region 1323. For example, the haptic type of the first local haptic region 1321 may be the dented feeling, the haptic type of the second local haptic region 1322 may be the three-dimensionally protruding feeling, and the haptic type of the third local haptic region 1323 may be the gentle wave feeling.

In FIG. 24B, a finger 1302, which is an example of an user input means, swipes in the arrow direction 1305 across first through third local haptic regions 1321 through 1323. The electronic device 2400 generates a haptic feedback/effect corresponding to the haptic types of local haptic regions 1321 through 1323 as the user input position intersects local haptic regions 1321 through 1323. As illustrated in FIG. 24B, to the electronic device 2400 sequentially generates vibration 1331 of the first local haptic region 1321 corresponding to the first haptic type, transformation 1332 of the second local haptic region 1322 corresponding to the second haptic type, and vibration 1333 of the third local haptic region 1323 corresponding to the third haptic type, as the finger 1302 sequentially passes by the first through third local haptic regions 1321 through 1323.

Local haptic region setting may be implemented in various ways, and other examples of local haptic region setting will be described below.

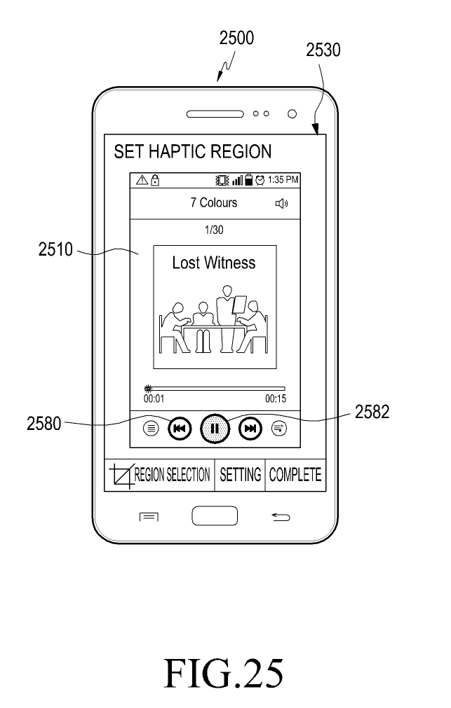

FIG. 25 illustrates a method of setting a local haptic region according to various embodiments of the present disclosure.

In FIG. 25, the electronic device 2500 primarily highlights (for example, indicates by a circle with no inner color) selectable candidate local haptic regions (for example, the rewind button 2580, the pause/play button 2582, and/or the fast-forward button) on representative image 2510. If the user selects a local haptic region from among the candidate local haptic regions, for example, selects the pause/play button 2582 from among the rewind button 2580, the pause/play button 2582, and the fast-forward button by performing a hovering action or a touch action, then the device secondarily highlights (for example, indicates by a circle with an inner color filled therein) the selected local haptic region, that is, secondarily highlights the pause/play button 2582. Such selection is used to mean execution or selection of a menu.

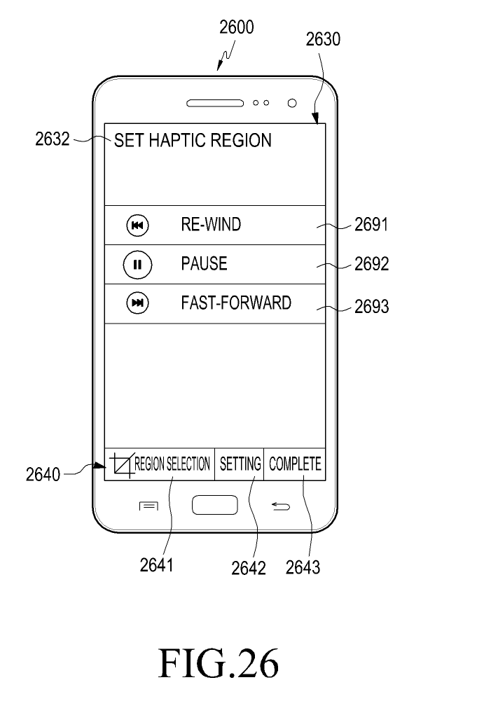

FIG. 26 illustrates a method of setting a local haptic region according to various embodiments of the present disclosure.

In FIG. 26, electronic device 2600 displays a phrase 2632 for guiding selection of a local haptic region (e.g., “SET HAPTIC REGION”) and selectable candidate local haptic regions 2691, 2692, and 2693 on a local haptic environment setting screen 2630, where each of the first through third candidate local haptic regions 2691, 2692, and 2693 is displayed with an image and a text describing the image. Specifically, the first candidate local haptic region 2691 corresponds to the rewind button, the second candidate local haptic region 2692 corresponds to the pause/play button, and the third candidate local haptic region 2693 corresponds to the fast-forward button.

The local haptic environment setting screen 2630 displays the environment setting menu 2640, which includes the region selection button 2641, the setting button 2642, and the complete button 2643. If the user selects the region selection button 2641, the device displays the local haptic environment setting screen 930 as illustrated in FIG. 7B. That is, the local haptic environment setting screen may be displayed in an image-based mode (such as in FIG. 7B), a text-based mode (such as in FIG. 26), or a combination mode thereof, and the user may switch between the two modes by selecting a preset button.

In FIG. 26, if the user selects one of the first through third candidate local haptic regions 2691, 2692, and 2693, and then selects the setting button 2642, a haptic type setting screen is displayed, such as haptic type setting screen 930b illustrated in FIG. 7D. In the haptic type setting screen, the user either selects a haptic type to be applied to the selected local haptic region or terminates local haptic environment setting. Local haptic environment settings determined by the user are stored in a memory.

Methods for setting and providing local haptic regions according to various embodiments of the present disclosure may be applied to various applications. The application may be any application, such as, for example, an Operating System (OS), a voice recognition application, a schedule management application, a document creation application, a music application, an Internet application, a map application, a camera application, an e-mail application, an image editing application, a search application, a file search application, a video application, a game application, a Social Networking Service (SNS) application, a call application, and/or a message application.

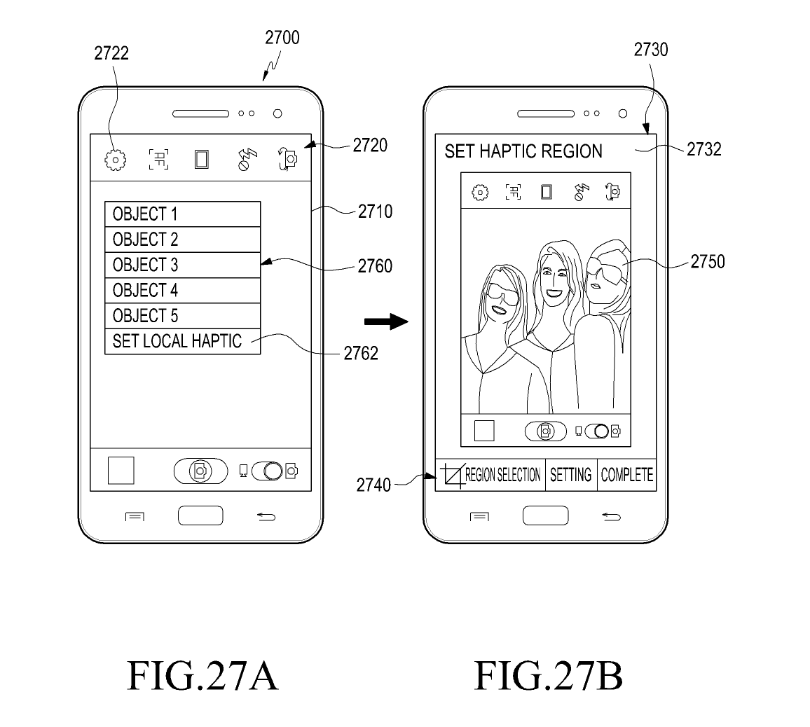

FIGS. 27A and 27B illustrate a method for setting a local haptic region according to various embodiments of the present disclosure.

In FIG. 27A, electronic device 2700 executes a camera application and detects a user input selecting environment setting icon/button 2722 in the top camera function menu 2720 of camera application screen 2710. According to the user input, the electronic device 2700 displays environment setting pop-up menu 2760, which includes local haptic environment setting icon/button 2762, on the camera application screen 2710. When the user selects the local haptic environment setting icon/button 2762, local haptic environment setting screen 2730, as shown in FIG. 27B, is displayed.

In embodiments of the present disclosure, to select the local haptic environment setting function, the user may, for example, a) press the button of an input/output device, b) select an object in another way through a display, c) input a preset pattern (for example, a double-tap, a motion of putting two fingers which are touching the screen together or apart, or a motion of drawing a circle with a finger which is touching the screen) on the display, d) input a voice command through a microphone, e) generate a gesture or a motion input through a camera module, or f) wirelessly input a particular command through a communication device (such as, e.g., the communication module 170 or the communication module 220).

FIG. 27B displays the local haptic environment setting screen 2730 for the camera application, which the user brought up by selecting the local haptic environment setting button/icon 2762 in FIG. 27A. The local haptic environment setting screen 2730 displays capture screen 2750 of the camera application in a size-reduced form, the phrase 2732 for guiding selection of the local haptic region (“SET HAPTIC REGION”), and the environment setting menu 2740.

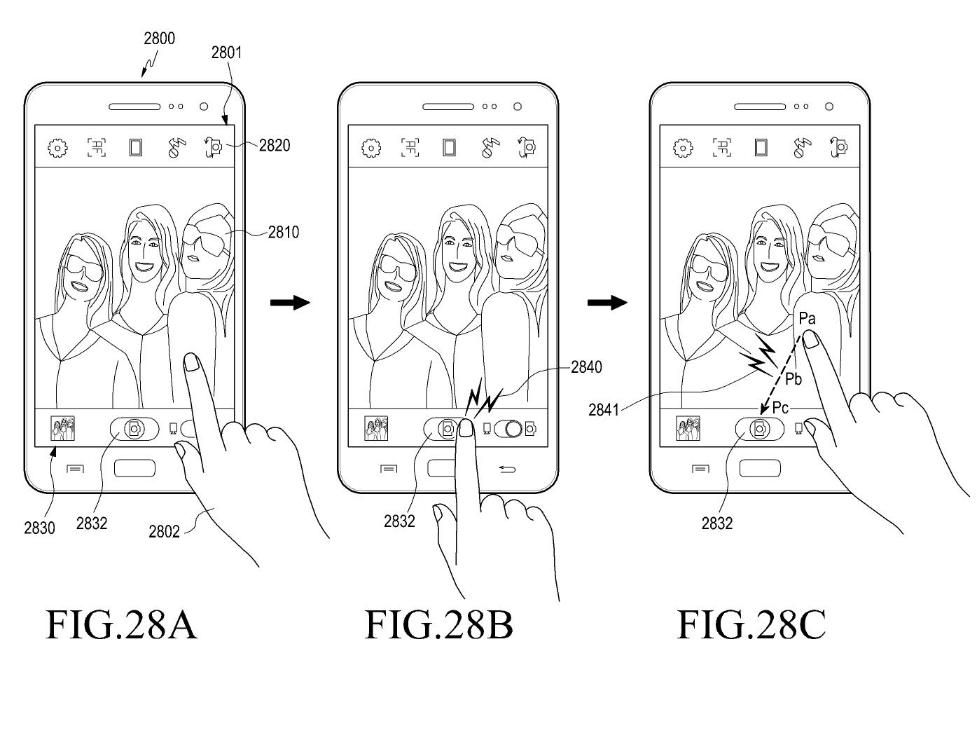

FIGS. 28A through 28C illustrate a method for providing a local haptic region according to various embodiments of the present disclosure.

In FIG. 28A, electronic device 2800 displays a camera application screen 2801 on its display. The camera application screen has a first menu 2820, a second menu 2830, and a capture screen 2810. The first menu 2820 includes an environment setting button, and/or the like, and the second menu 2830 includes a capture button corresponding to a local haptic region 2832, and/or the like. For the local haptic region 2832, the second haptic type giving the protruding feeling is set.

As illustrated in FIG. 28A, the user searches for the local haptic region 2832 on the camera application screen 2801 with a finger 2802. The electronic device 2800 continuously determines whether the user input position corresponding to a touch or hovering position of the finger 2802 intersects the local haptic region 2832.

In FIG. 28B, the user input position intersects the local haptic region 2832, that is, finger 2802 touches or approaches the capture button, then the electronic device 2800 generates haptic feedback/effect vibration 2840, of the second haptic type, which gives the protruding feeling, and thus the user may recognize that his/her finger 2802 is touching the capture button or is positioned adjacent to the capture button, without viewing the display. This may be useful, for example, for a blind or visually impaired person who has difficulty in visually locating and pressing the small area of the capture button. Instead, a local haptic region is mapped to a larger area including the capture button, thereby allowing the capture button to be selected merely by feeling for the local haptic region, thereby helping a blind or visually impaired person select the button.

Once the capture button is located by haptic feedback, as shown in FIG. 28B, the user may select the capture button through a touch motion in order to capture the camera scene displayed on the capture screen 2820. Depending on the embodiment, a haptic module may also generate a haptic feedback/effect corresponding to the user's selection (or click) of the capture button.

In FIG. 28C, the user has not found the haptic region, and the electronic device outputs guide information to help the user find the haptic region (capture button). First, the user's finger contacts the screen at position Pa, located within the capture screen 2810, and the electronic device outputs a vibration 2841 indicative of the distance to the local haptic region (capture button). As the user's finger moves closer, such as at position Pb, vibration 2841 changes to indicate the user's finger is closer to the local haptic region and continues to change until the user's finger is guided to position Pc, the location of the local haptic region.

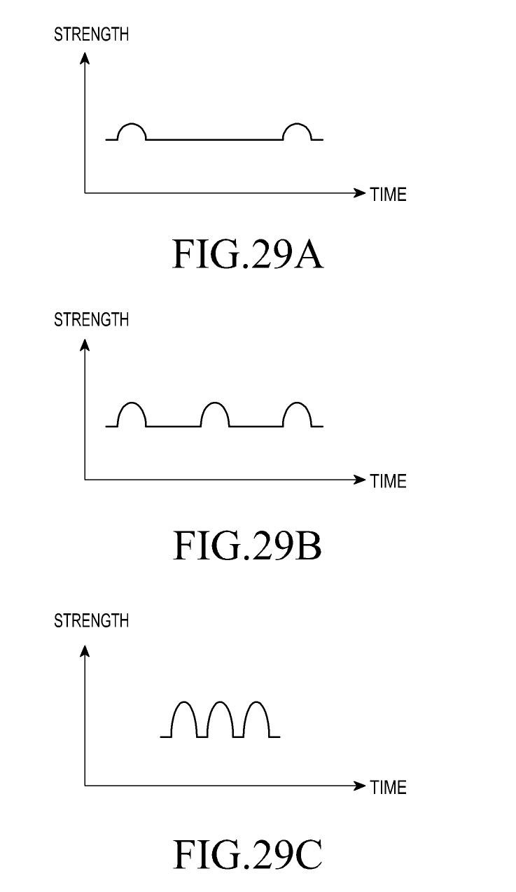

FIGS. 29A through 29C are graphs illustrating how a vibration may change to provide guidance for a user to find a local haptic region, using the specific example of FIG. 28C. In FIGS. 29A through 29C, the horizontal axis indicates time and the vertical axis indicates vibration strength.

FIG. 29A illustrates the vibration generated when the user's finger is in position Pa in FIG. 28C, the furthest away from the local haptic region. FIG. 29B shows the vibration when the user's finger is at the intermediate position Pb in FIG. 28C. FIG. 29C illustrates vibration in the position Pc when the user's finger has found the local haptic region 2832.

Accordingly, as shown in FIGS. 29A through 29C, as the user contact/contactless touch position approaches the local haptic region 2832 in FIG. 28C, the frequency and strength of the vibrations increase. Conversely, when the user contact/contactless touch position moves away from the local haptic region 2832, the frequency and strength of the vibrations decrease.

In other embodiments, as the user contact/contactless touch position approaches a local haptic region, either the vibration frequency or the vibration strength may increase or decrease. For example, to allow the user to clearly recognize that the user input position is approaching the local haptic region, the vibration frequency may increase while the vibration strength maintains constant, or the vibration strength may sharply increase when the user input position intersects the local haptic region. Although the vibration for guidance in FIGS. 29A through 29C is the second haptic type (the protruding feeling), the vibrations for guidance may be in other forms, such as a pulse, depending on the embodiment.

Other output may be used for guidance. For example, a guide voice, together with or instead of vibration, may be output and, as the user input position approaches the local haptic region, vary the interval and/or strength of the guidance voice. For example, if the guidance word is “Capture,” as the user input position approaches the local haptic region, the time interval between the first output/syllable of the voice/word (e.g., “Cap-”) and the second output/syllable of the voice/word (e.g., “-ture”) may decrease.

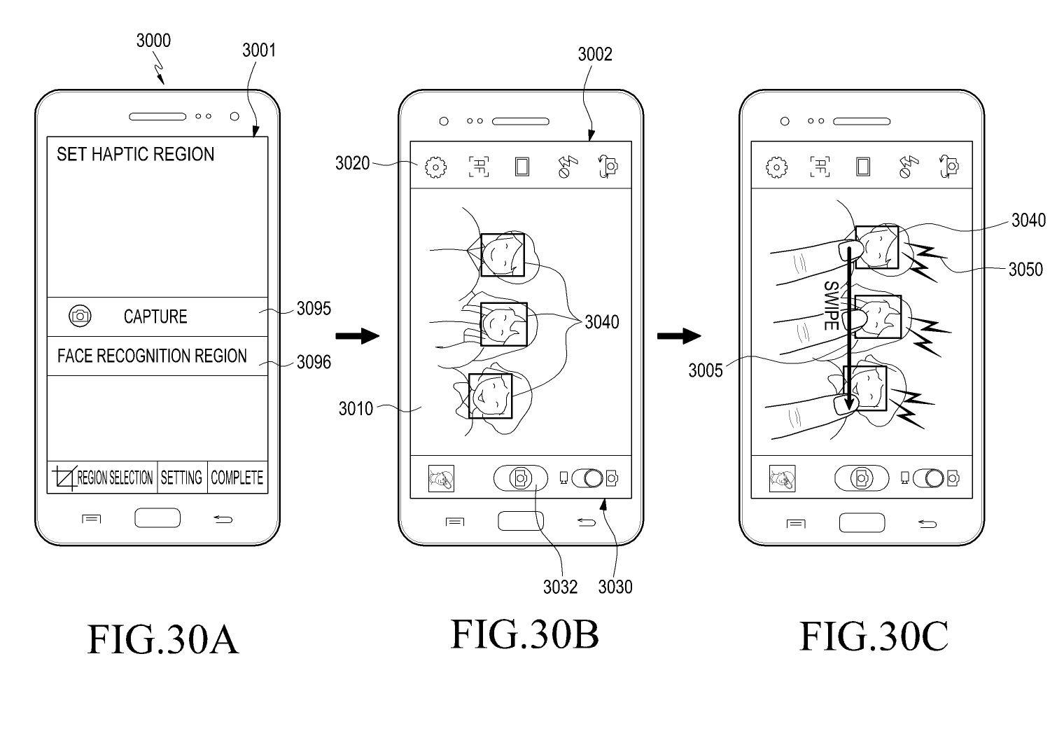

FIGS. 30A through 30C illustrate a method for setting and providing a local haptic region in an image according to various embodiments of the present disclosure.

In FIG. 30A, electronic device 3000 displays a local haptic environment setting screen 3001 for a camera application, which has a first local haptic setting region 3095 corresponding to a capture button and a second local haptic setting region 3096 corresponding to a subject recognition region (for example, a face or finger recognition region), which is automatically recognized in capturing. If the user selects the second local haptic setting region 3096, the user can easily determine whether a desired subject (i.e., at least one user face) is entirely included in a view of the camera module or the subject is properly positioned in capturing

In FIG. 30B, a camera application screen 3002 is displayed on the electronic device 3000, having a first menu 3020, a second menu 3030, and a capture screen 3010. The first menu 3020 includes an environment setting button, and/or the like, the second menu 3030 includes a capture button 3032 and the like. In FIG. 3B, the face recognition region is set as the three boxes 3040.

The face recognition process is performed with respect to an image captured by the camera module and, upon completing the face recognition, guide information for notifying the user of completion of the face recognition is output. The guide information may be output in the form of vibration or sound.

In FIG. 30C, a haptic feedback/effect, e.g., vibration 3050, corresponding to the haptic type set in the local haptic region 3040 is generated if the user input position intersects the local haptic region 3040. Accordingly, as illustrated in FIG. 30C, when the user's finger swipes in arrow direction 3005, vibration 3050 is generated each time the finger passes by one of the three boxes comprising face recognition region 3040

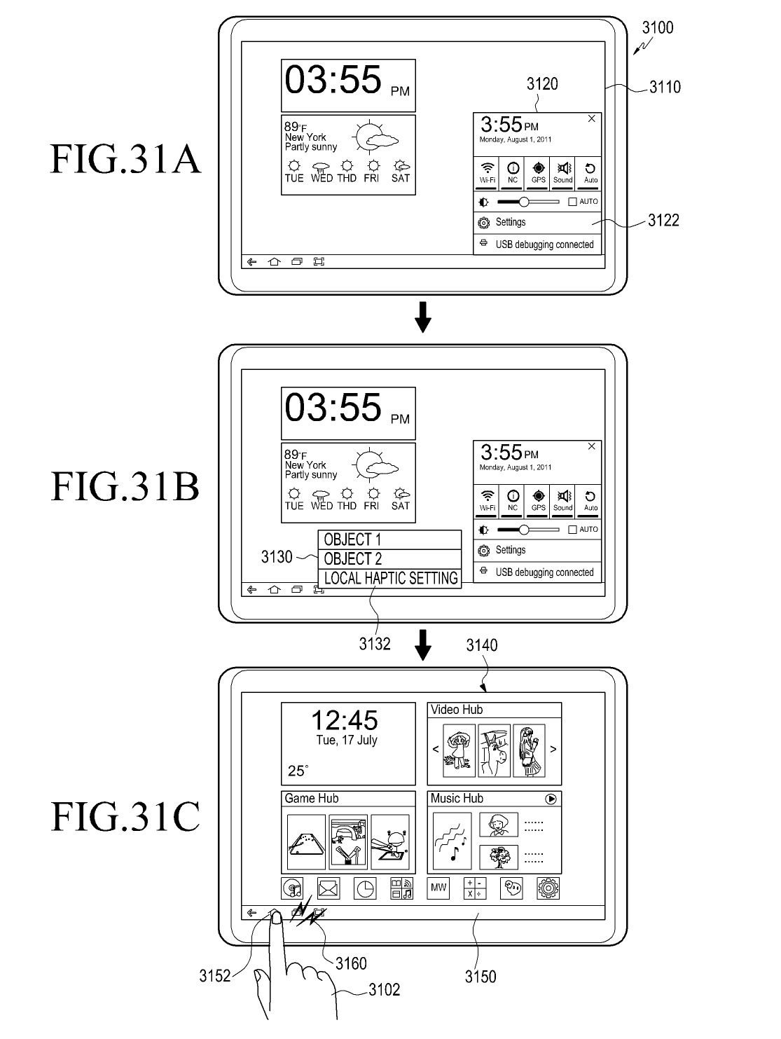

FIGS. 31A through 31C illustrate a method for setting and providing a local haptic region in a home screen according to various embodiment of the present disclosure.

In FIG. 31A, electronic device 3100 displays a first main home screen 3110 with a basic menu 3120, which includes a settings button 3122. The user input selects settings button 3122 in the basic menu 3120, which brings up environment setting pop-up menu 3130, as shown in FIG. 31B.

In FIG. 31B, environment setting pop-up menu 3130 is displayed on the first main home screen 3110, and contains menu items or buttons for various environment settings. The menu items may be referred to as function items. The user selects local haptic environment setting button 3132 (“LOCAL HAPTIC SETTING”), so that the user may assign a local haptic region to the first main home screen 3110 or another home screen, that is, for an OS screen.

In FIG. 31C, second main home screen 3140 has a task bar 3150 including a home button corresponding to a local haptic region 3152, as well as other buttons (a back button, a multi-tasking button, a screen capture button, or the like), at the bottom of the second main home screen 3140.

A haptic feedback/effect, e.g., vibration 3160, corresponding to the haptic type which is assigned to the local haptic region 3152, is generated when the user input position intersects the local haptic region 3152. As illustrated in FIG. 31C, the user's finger 3102 searches for the local haptic region 3152 (previously set by the user) on the main home screen 3140. The electronic device 3100 continuously determines whether the touch or hovering position of the finger 3102 intersects the local haptic region 3152.

If the user input position intersects the local haptic region 3152, that is, the user's finger 3102 touches or approaches the local haptic region 3152, then the haptic feedback/effect, e.g., the vibration 3160, corresponding to the second haptic type is generated, giving the user the protruding feeling, whereby the user recognizes that the finger 3102 is touching or is positioned adjacent to the local haptic region 3152, without viewing the main home screen 3140.

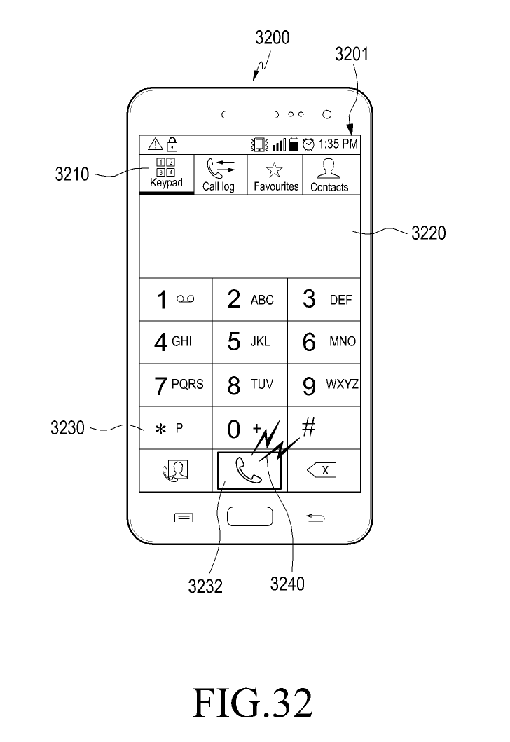

FIG. 32 illustrates a method for providing a local haptic region for a call application according to various embodiment of the present disclosure. The method for setting a local haptic region for a call application can be the same as any of the above-described methods, and thus only the method for providing a local haptic region is described herein.

In FIG. 32, electronic device 3200 displays a call application screen 3201. The call application screen 3201 includes a menu 3210 including a keypad, a call log, favorites, contacts, an input window 3220 for inputting a phone number or the like, a keypad 3230 including key buttons for inputting a number, a character, a symbol, and/or the like, and a call button corresponding to a local haptic region 3232, for which the second haptic type/pattern giving the protruding feeling is set.

A haptic feedback/effect, e.g., vibration 3240, corresponding to the haptic type set in the local haptic region 3232, is generated if the user input position intersects the local haptic region 3232. While the user searches for the user-set local haptic region 3232 on the call application screen 3201, the electronic device 3200 continuously determines whether the user input position corresponding to the input position (that is, the touch or hovering position) of the user input means intersects the local haptic region 3232.

If the user input position intersects the local haptic region 3232, that is, the user touches or approaches the local haptic region 3232 with a finger or a pen, then the haptic feedback/effect vibration 3240 corresponding to the second haptic type is generated. Since the user feels the haptic feedback/effect giving the protruding feeling, the user recognizes that the user input means is touching or is positioned adjacent to the local haptic region 3232, without viewing the call application screen 3201.

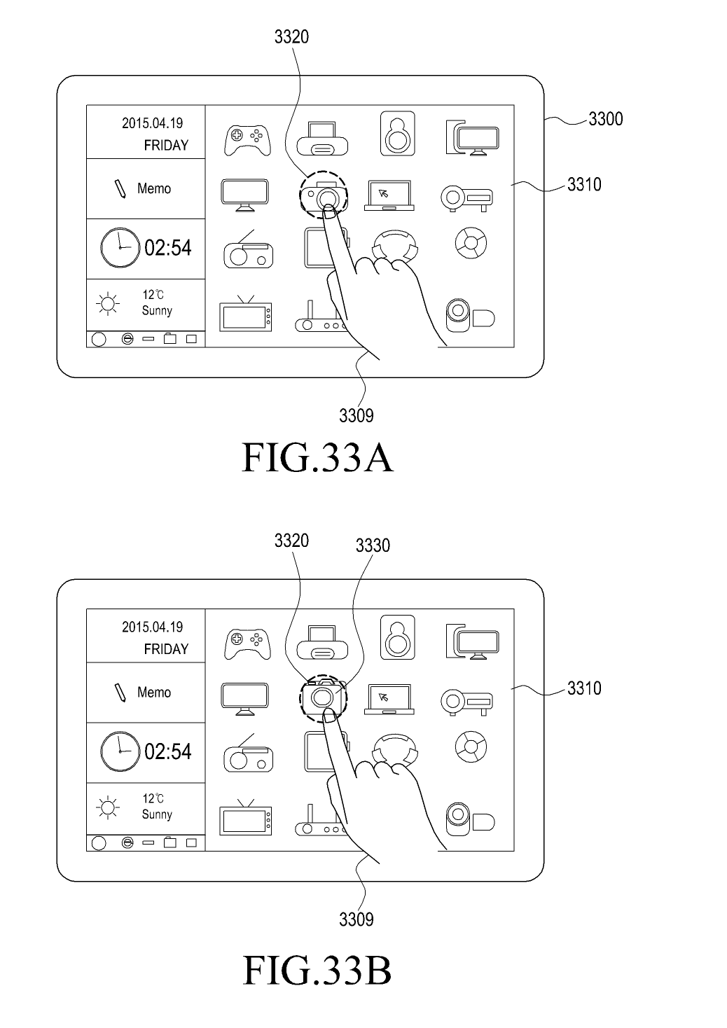

FIGS. 33A and 33B illustrate a method for providing a local haptic region according to various embodiments of the present disclosure.

In FIG. 33A, electronic device 3300 displays a home screen 3310 with a plurality of icons. The second haptic type giving the three-dimensionally protruding feeling is assigned to a local haptic region 3320 corresponding to an icon on home screen 3310. If the input position of the finger of a user's hand 3309 intersects the local haptic region 3320, the haptic feedback/effect transformation 3330 corresponding to the haptic type assigned to the local haptic region 3320 is generated, as shown in FIG. 33B. While the user searches for the local haptic region 3320, the electronic device continuously determines whether the user's touch or hovering to position intersects the local haptic region 3320.

When the user input position intersects the local haptic region 3320, that is, if the user's finger touches or approaches the local haptic region 3320, then the haptic feedback/effect transformation 3330 corresponding to the second haptic type is generated. The user feels the haptic feedback/effect giving the three-dimensionally protruding feeling, thereby recognizing that the user input means touches or approaches the local haptic means 3320, without viewing the home screen 3310.

According to various embodiments of the present disclosure, a method for providing a haptic effect in an electronic device includes displaying an application screen having a haptic providing region on a display (e.g., a touch screen); detecting a user input (e.g., a touch) in the haptic providing region; and providing a haptic effect corresponding to the haptic providing region in response to the detected user input, in which the haptic effect includes transformation of at least a portion of the haptic providing region.

According to various embodiments of the present disclosure, the haptic effect may be set by a user; the user input may be generated by at least one of a finger and an input unit; the user input may be generated by a contact on the display or hovering over the display; detecting the user input includes detecting a continuous movement of touch and detecting an intersection of the continuous movement of the touch with the haptic providing region; a type (or a pattern) of a haptic effect corresponding to an immediate touch and a type (or a pattern) of a haptic effect corresponding to the intersecting touch may be different from each other; and/or the continuous movement of the touch may include at least one of a drag, a flick, and a swipe.

According to various embodiments of the present disclosure, the haptic providing region may include at least one of a key, a button, a text, an image, a shortcut icon, an icon, and a menu displayed on the application screen; providing the haptic effect may include providing vibration (and/or sound); the haptic effect may include vibration, and a waveform of the vibration may include one of a protruding form, a dented form, a sine waveform, and a triangular waveform; and/or providing the haptic effect may include transmitting a control signal corresponding to the haptic effect to an input unit.

According to various embodiments of the present disclosure, the method may further include setting one of the executable menus of an application as the haptic providing region and setting a haptic type to be applied to the haptic providing region from among a plurality of haptic types; and/or displaying the application screen to the user and receiving selection information with respect to a portion of the application screen from the user, in which the selected portion of the application screen is set as the haptic providing region.

According to various embodiments of the present disclosure, an electronic device for providing a haptic effect includes a display configured to sense a user input position and output an image, a haptic module configured to generate a haptic effect, and a controller or processor configured to display an application screen having a haptic providing region on the display, to detect a user input on the haptic providing region, and to provide a haptic effect corresponding to the haptic providing region in response to the detected user input, in which the haptic effect includes transformation of a portion of the haptic providing region.

According to various embodiments of the present disclosure, the processor is configured to detect continuous movement of touch and to detect an intersection of the continuous movement of the touch with the haptic providing region; and/or the processor is configured to transmit a control signal corresponding to the haptic effect to an input unit.

According to various embodiments of the present disclosure, the haptic module may include a plurality of haptic elements, each of which is disposed to correspond to at least one pixels of the display; a fluid reservoir configured to store fluid and a tactile layer on a surface of the display, in which the processor applies a voltage to some of the plurality of haptic elements, which correspond to the haptic providing region, to cause a portion of the tactile layer to to protrude; a membrane including a plurality of channels serving as a path through which the fluid in the fluid reservoir moves to the tactile layer; and/or a first electrode and a second electrode for applying a voltage to the fluid.

According to various embodiments of the present disclosure, each of the plurality of haptic elements may include a piezoelectric element configured to be bent toward the tactile layer according to an applied voltage and may include a piezoelectric element configured to extend toward the tactile layer according to an applied voltage.

The present disclosure provide a user a haptic effect to find and/or select screen items without the need for viewing the display, thereby allowing the user to easily find and use various functions, applications, and operations of an electronic device.

As examples, according to the present disclosure, when the user turns over a camera/phone to capture his/her self-image in a self-camera mode, the user can easily find the capture button without viewing the screen, and the user on the move may also find and use the re-wind button in the electronic device while kept in the pocket. Moreover, a visually-handicapped person, when capturing an image, may easily recognize and locate a face recognition result and a position of a face recognition region.

A term “module” used herein may mean, for example, a unit including one of or a combination of two or more of hardware, software, and firmware. The “module” may be interchangeably used with a unit, logic, a logical block, a component, or a circuit. The “module” may be a minimum unit or a portion of an integrated component. The “module” may be a minimum unit or a portion thereof performing one or more functions. The “module” may be implemented mechanically or electronically. For example, the “module” according to the embodiments may include at least one of an application-specific integrated circuit (ASIC) chip, field-programmable gate arrays (FPGAs), and a programmable-logic device performing certain operations already known or to be developed.

At least a part of a device (for example, modules or functions thereof) or a method (for example, operations) according to various embodiments of the present disclosure may be implemented with one or more commands stored in a non-transitory computer-readable storage medium in the form of a program module, an application, a list of executable instructions, etc. When the commands are executed by one or more processors, the one or more processors perform one or more functions corresponding to the commands.

The non-transitory computer readable recording medium includes, but is not limited to, magnetic media such as hard disk, floppy disk, or magnetic tape, optical media such as compact disc read only memory (CD-ROM) or digital versatile disc (DVD), magneto-optical media such as a floptical disk, and a hardware device such as Read-Only Memory (ROM), Random Access Memory (RAM), and flash memory. Further, the program instructions may include a machine language code created by a complier and a high-level language code executable by a computer using an interpreter. The foregoing hardware device may be configured to be operated as at least one software module to perform an operation of the present disclosure, or vice versa.

Modules or programming modules according to various embodiments of the present disclosure may include one or more of the foregoing elements, have some of the foregoing elements omitted, or further include additional other elements. Operations performed by the modules, the programming modules or other elements may be executed in a sequential, parallel, repetitive, or heuristic manner.

According to various embodiments of the present disclosure, a storage medium having stored thereon commands that, when executed by at least one processors, are set to cause the processor to perform at least one operation including displaying an application screen including a haptic providing region set by a user on a display, detecting a user input in the haptic providing region, and providing a haptic effect corresponding to the haptic providing region in response to the detected user input, in which the haptic effect includes transformation of at least a portion of the haptic providing region.

The embodiments disclosed herein have been provided for description and understanding of disclosed technical matters, and are not intended to limit the scope of the present disclosure. Therefore, it should be understood that the scope of the present disclosure includes any modifications or changes based on the technical spirit of the present disclosure.

What is claimed is:

1. A method for providing a haptic effect in an electronic device, the method comprising:
displaying an application screen comprising a haptic providing region on a display;
detecting a user input in the haptic providing region; and
providing a haptic effect corresponding to the haptic providing region in response to the detected user input,
wherein the haptic effect comprises transformation of at least a portion of the haptic providing region.

2. The method of claim 1, wherein the user input comprises a contact on the display or hovering over the display.

3. The method of claim 1, wherein the haptic providing region comprises at least one of a key, a button, a text, an image, a shortcut icon, an icon, and a menu displayed on the application screen.

4. The method of claim 1, wherein providing the haptic effect comprises:
providing vibration.

5. The method of claim 1, wherein providing the haptic effect comprises:
transmitting a control signal corresponding to the haptic effect to a haptic unit.

6. The method of claim 1, wherein the haptic effect comprises vibration, and a waveform of the vibration comprises one of a protruding form, a dented form, a sine waveform, and a triangular waveform.

7. The method of claim 1, further comprising:
setting an executable visual element of an application as the haptic providing region; and
setting a haptic type to be applied to the haptic providing region from among a plurality of haptic types.

8. The method of claim 7, wherein setting the executable visual element of the application as the haptic providing region comprises:
displaying the application screen to the user; and
receiving selection information with respect to a portion of the application screen from the user,
wherein the selected portion of the application screen includes the executable visual element and is set as the haptic providing region.

9. A non-transitory machine-readable recording medium having recorded thereon a program for causing at least one processor to execute a method for providing a haptic effect in an electronic device, the method comprising:
displaying an application screen comprising a haptic providing region on a display;
detecting a user input in the haptic providing region; and
providing a haptic effect corresponding to the haptic providing region in response to the detected user input,
wherein the haptic effect comprises transformation of at least a portion of the haptic providing region.

10. An electronic device comprising:
a display which senses input and outputs images;
a haptic module; and
a processor which:
controls the display to display an application screen comprising a haptic providing region;
detects a user input on the haptic providing region; and
controls the haptic module to provide a haptic effect corresponding to the haptic providing region in response to the detected user input,
wherein the haptic effect comprises transformation of at least a portion of the haptic providing region.

11. The electronic device of claim 10, wherein the user input comprises a contact on the display or hovering over the display.

12. The electronic device of claim 10, wherein the haptic providing region comprises at least one of a key, a button, a text, an image, a shortcut icon, an icon, and a menu displayed on the application screen.

13. The electronic device of claim 10, wherein the processor controls the haptic module to provide vibration corresponding to the user input.

14. The electronic device of claim 10, wherein the haptic effect comprises vibration, and a waveform of the vibration comprises one of a protruding form, a dented form, a sine waveform, and a triangular waveform.

15. The electronic device of claim 10, wherein the haptic module comprises:
a plurality of haptic elements, each of which is disposed to correspond to at least one pixel of the display.

16. The electronic device of claim 15, wherein the haptic module comprises:
a fluid reservoir configured to store fluid; and
a tactile layer on a surface of the display,
wherein the processor applies a voltage to some of the plurality of haptic elements, which correspond to the haptic providing region, to cause a portion of the tactile layer to protrude.

17. The electronic device of claim 16, wherein the haptic module further comprises:
a membrane comprising a plurality of channels serving as a path through which the fluid in the fluid reservoir moves to the tactile layer.

18. The electronic device of claim 16, wherein the haptic module further comprises:
a first electrode and a second electrode for applying a voltage to the fluid.

19. The electronic device of claim 15, wherein each of the plurality of haptic elements comprises:
a piezoelectric element configured to be bent toward the tactile layer according to an applied voltage.

20. The electronic device of claim 15, wherein each of the plurality of haptic elements comprises:
a piezoelectric element configured to extend toward the tactile layer according to an applied voltage.
